(19) United States
(12) Patent Application Publication
(10) Pub. No.: US 2026/0273660 A1
(43) Pub. Date: Sep. 17, 2026

(54) WELDING DEVICE

(71) Applicant: SK On Co., Ltd., Seoul (KR)

(72) Inventors: Deok Min JEON, Daejeon (KR); Oh San AN, Daejeon (KR); Ji Yoon YOUM, Daejeon (KR); Seul Gi LEE, Daejeon (KR); Min Jeong HONG, Daejeon (KR)

(21) Appl. No.: 19/560,140

(22) Filed: Mar. 9, 2026

(30) Foreign Application Priority Data
Mar. 11, 2025 (KR) 10-2025-0031472

(51) Int. Cl. B23K 26/21; B23K 26/03; B23K 26/082

(52) U.S. Cl. CPC B23K 26/21; B23K 26/032; B23K 26/082

(57) ABSTRACT

A welding device according to embodiments of the present disclosure includes a laser configured to irradiate laser beam having a first wavelength toward a welding object, a lighting configured to irradiate light having a second wavelength different from the first wavelength onto a laser irradiation area of the welding object, a first camera configured to receive the light having the second wavelength, which is reflected from the welding object, so as to generate a first image, and a second camera configured to receive the light having the second wavelength, which is reflected from the welding object, so as to generate a second image, wherein a generation period of the first image and a generation period of the second image intersect each other.

### CROSS-REFERENCE TO RELATED APPLICATIONS

The present application claims priority under 35 U.S.C. § 119(a) to Korean patent application number 10-2025-0031472, filed on Mar. 11, 2025, the entire disclosure of which is incorporated herein by reference.

### BACKGROUND

### 1. Technical Field

Embodiments of the present disclosure relate to a welding device.

### 2. Related Art

A welding process using a laser and a camera has the advantage of providing high precision while performing an operation at a high speed. In particular, the higher resolution of the camera, the more accurate a welding position may be selected. In the welding process, it is important to evaluate a welding state in real-time through ultra-high-speed imaging, and thus, both resolution and a frame rate of the camera has to be improved simultaneously.

However, when the camera resolution increases, there is a tendency for the frame rate to decrease, which may lead to difficulties in simultaneously improving both the aspects. That is, if the frame rate increases in order to attempt more precise evaluation of the welding state, the resolution may decrease to lead to a decrease in precision when selecting the welding position.

### SUMMARY

An embodiment of the present disclosure provides more precise evaluation in welding state and improved accuracy in selection of a welding position by cross-photographing a welding object using a plurality of cameras.

Another embodiment of the present disclosure provides a wider viewing angle by differently aligning a photographing area of a welding object and simultaneously photographing the photographing area using a plurality of cameras.

Further another embodiment of the present disclosure provides accurate evaluation in various welding states of a welding object by using lightings having different wavelength bands and cameras that recognize the lightings.

A welding device according to embodiments of the present disclosure includes: a laser configured to irradiate laser beam having a first wavelength toward a welding object; a lighting configured to irradiate light having a second wavelength different from the first wavelength onto a laser irradiation area of the welding object; a first camera configured to receive the light having the second wavelength, which is reflected from the welding object, so as to generate a first image; and a second camera configured to receive the light having the second wavelength, which is reflected from the welding object, so as to generate a second image, wherein a generation period of the first image and a generation period of the second image intersect each other.

In an embodiment, the welding device may further include a data processing device configured to supply a first trigger signal to the first camera and supply a second trigger signal to the second camera so as to control the first camera and the second camera, wherein the first trigger signal may be in the form of a pulse, and the second trigger signal may be in the form of the first trigger signal that is delayed by as much as a length of the generation period of the first image.

In an embodiment, when the first trigger signal is at a high level, the first camera may be configured to generate the first image and transmit the generated first image to the data processing device, and when the first trigger signal is at a low level, the first camera may be turned off, when the second trigger signal is at a high level, the second camera may be configured to generate the second image and transmit the generated second image to the data processing device, and when the second trigger signal is at a low level, the second camera may be turned off, and the generation period of the second image may overlap a transmission period of the first image and a turn-off period of the first camera.

In an embodiment, the lengths of the generation period of the first image and the transmission period of the first image may be the same.

In an embodiment, the welding device may further include: a beam splitter configured to separate the light having the second wavelength, which is reflected from the welding object, and transmit the separated light to the first camera and the second camera, respectively; a scanner configured to adjust a traveling direction of the light having the second wavelength, which is reflected from the laser and the welding object; a first mirror configured to receive the laser beam from the laser and transmit the received laser beam to the scanner, and receive the light having the second wavelength, which is reflected from the welding object, and transmit the received light from the scanner; and a second mirror configured to receive the light having the second wavelength from the first mirror and transmit the light to the beam splitter.

In an embodiment, the light having the second wavelength, which is separated by the beam splitter and transmitted to the first camera and the second camera, may have the same phase.

In an embodiment, the second wavelength may be in a range of about 400 nm to about 700 nm.

A welding device according to embodiments of the present disclosure includes: a laser configured to irradiate laser beam having a first wavelength toward a welding object; a lighting configured to irradiate light having a second wavelength different from the first wavelength onto a laser irradiation area of the welding object; a first camera configured to receive the light having the second wavelength, which is reflected from the welding object, so as to generate a first image; a second camera configured to receive the light having the second wavelength, which is reflected from the welding object, so as to generate a second image; a third camera configured to receive the light having the second wavelength, which is reflected from the welding object, so as to generate a third image; and a fourth camera configured to receive the light having the second wavelength, which is reflected from the welding object, so as to generate a fourth image, wherein periods during which the first to fourth images are generated do not overlap each other and are sequentially repeated.

In an embodiment, the welding device may further include a data processing device configured to supply a first trigger signal to the first camera, supply a second trigger signal to the second camera, supply a third trigger signal to the third camera, and supply a fourth trigger signal to the fourth camera so as to control the first to fourth cameras, wherein the first trigger signal may be in the form of a pulse, the second trigger signal may be in a form in which the first trigger signal that is delayed by as much as a length of the generation period of the first image, the third trigger signal may be in a form in which the second trigger signal is delayed by as much as a length of the generation period of the second image, and the fourth trigger signal may be in a form in which the third trigger signal delayed by as much as a length of the generation period of the third image.

In an embodiment, when the first trigger signal is at a high level, the first camera may be configured to generate the first image and transmit the generated first image to the data processing device, and when the first trigger signal is at a low level, the first camera may be turned off, when the fourth trigger signal is at a high level, the fourth camera may be configured to generate the fourth image and transmit the generated fourth image to the data processing device, and when the fourth trigger signal is at a low level, the fourth camera may be turned off, and the generation period of the fourth image may overlap a transmission period of the first image and a turn-off period of the first camera.

A welding device according to embodiments of the present disclosure includes: a laser configured to irradiate laser beam having a first wavelength toward a welding object; a first lighting configured to irradiate light having a second wavelength different from the first wavelength onto a laser irradiation area of the welding object; a second lighting configured to irradiate light having a third wavelength different from each of the first wavelength and the second wavelength onto the laser irradiation area of the welding object; a first camera configured to receive the light having the second wavelength, which is reflected from the welding object, so as to generate a first image; and a second camera configured to receive the light having the third wavelength, which is reflected from the welding object, so as to generate a second image, wherein a generation period of the first image and a generation period of the second image intersect each other.

In an embodiment, the welding device may further include a data processing device configured to supply a first trigger signal to the first camera and supply a second trigger signal to the second camera so as to control the first camera and the second camera, wherein the first trigger signal may be in the form of a pulse, and the second trigger signal may be in the form of the first trigger signal that is delayed by as much as a length of the generation period of the first image.

In an embodiment, when the first trigger signal is at a high level, the first camera may be configured to generate the first image and transmit the generated first image to the data processing device, and when the first trigger signal is at a low level, the first camera may be turned off, when the second trigger signal is at a high level, the second camera may be configured to generate the second image and transmit the generated second image to the data processing device, and when the second trigger signal is at a low level, the second camera may be turned off, and the generation period of the second image may overlap a transmission period of the first image and a turn-off period of the first camera.

In an embodiment, the welding device may further include: a scanner configured to adjust traveling directions of the laser beam, the light having the second wavelength, which is reflected from the welding object, and the light having the third wavelength, which is reflected from the welding object; a first mirror configured to receive the laser beam from the laser and transmit the received laser beam to the scanner, and receive the light having the second wavelength and the light having the third wavelength, which are reflected from the welding object, from the scanner and allow the light to pass therethrough; a second mirror configured to transmit the light having the second wavelength, which is received from the first mirror, to the first camera, and allow the light having the third wavelength, which is received from the first mirror, to pass therethrough; and a third mirror configured to transmit the light having the third wavelength, which is received from the second mirror, to the second camera.

In an embodiment, the second wavelength may be in a range of about 400 nm to about 700 nm, and the third wavelength may be in a range of about 200 nm to about 400 nm.

A welding device according to embodiments of the present disclosure includes: a laser configured to irradiate laser beam having a first wavelength toward a welding object; a first lighting configured to irradiate light having a second wavelength different from the first wavelength onto a first area of the welding object; a second lighting configured to irradiate light having a third wavelength different from each of the first wavelength and the second wavelength onto a second area other than the first area of the welding object; a first camera configured to receive the light having the second wavelength, which is reflected from the first area of the welding object, so as to generate a first image; and a second camera configured to receive the light having the third wavelength, which is reflected from the second area of the welding object, so as to generate a second image, wherein a generation period of the first image and a generation period of the second image overlap each other.

In an embodiment, the welding device may further include a data processing device configured to supply a first trigger signal to the first camera and supply a second trigger signal to the second camera so as to control the first camera and the second camera, wherein the first trigger signal may be in the form of a pulse, and the second trigger signal may have the same phase as the first trigger signal.

In an embodiment, when the first trigger signal is at a high level, the first camera may be configured to generate the first image and transmit the generated first image to the data processing device, and when the first trigger signal is at a low level, the first camera may be turned off, and when the second trigger signal is at a high level, the second camera may be configured to generate the second image and transmit the generated second image to the data processing device, and when the second trigger signal is at a low level, the second camera may be turned off.

In an embodiment, the welding device may further include: a scanner configured to adjust traveling directions of the laser beam, the light having the second wavelength, which is reflected from the first area, and the light having the third wavelength, which is reflected from the second area; a first mirror configured to receive the laser beam from the laser and transmit the received laser beam to the scanner, and receive the light having the second wavelength, which is reflected from the first area, and the light having the third wavelength, which is reflected from the second area, from the scanner and allow the light to pass therethrough; a second mirror configured to receive the light having the second wavelength, which is reflected from the first area, from the first mirror and transmit the received light to the first camera, and receive the light having the third wavelength, which is reflected from the second area, from the first mirror and allow the light to pass therethrough; and a third mirror configured to receive the light having the third wavelength, which is reflected from the second area, from the second mirror and transmit the light to the second camera.

In an embodiment, each of the second wavelength and the third wavelength may be in a range of about 400 nm to about 700 nm.

### BRIEF DESCRIPTION OF THE DRAWINGS

FIG. 1 is a perspective view illustrating a welding device according to first and second embodiments.

FIG. 2 is a cross-sectional view taken along line I-I’ of the welding device of FIG. 1 according to the first embodiment.

FIG. 3 is a view for explaining a flow of a signal transmitted and received between components of the welding device of FIG. 2.

FIG. 4 is a view for explaining a path through which laser beam and light having a second wavelength within the welding device of FIG. 2.

FIGS. 5A and 5B are timing views for explaining an effect of the welding device of FIG. 2.

FIG. 6 is a cross-sectional view taken along line I-I’ of the welding device of FIG. 1 according to a second embodiment.

FIG. 7 is a view for explaining a flow of a signal transmitted and received between components of the welding device of FIG. 6.

FIG. 8 is a view for explaining a path through which laser beam and light having a second wavelength within the welding device of FIG. 6.

FIG. 9 is a timing view for explaining an effect of the welding device of FIG. 6.

FIG. 10 is a perspective view illustrating a welding device according to third and fourth embodiments.

FIG. 11 is a cross-sectional view taken along line II-II’ of the welding device of FIG. 10.

FIG. 12 is a view for explaining a flow of a signal transmitted and received between components of the welding device of FIG. 10.

FIG. 13 is a view for explaining a moving path of laser beam, light having a second wavelength, an light having a third wavelength within the welding device of FIG. 10 according to the third embodiment.

FIG. 14 is a timing view for explaining an effect of the welding device of FIG. 10 according to the third embodiment.

FIG. 15 is a view for explaining a moving path of laser beam, light having a second wavelength, an light having a third wavelength within the welding device of FIG. 10 according to the fourth embodiment.

FIG. 16 is a timing view for explaining an effect of the welding device of FIG. 10 according to the fourth embodiment.

### DETAILED DESCRIPTION

Preferred embodiments of the present disclosure will be described below in more detail with reference to the accompanying drawings. A configuration or control method of the device described below is only for explaining embodiments of the present disclosure and is not intended to limit the scope of the present disclosure, and the same reference numbers used throughout the specification indicate the same components.

A battery assembly according to the present disclosure is a concept that collectively refers to a battery module, a battery pack, and an energy storage system. The battery module refers to a battery assembly in which a plurality of battery cells are grouped in one or more numbers to protect the battery cells against external impacts, heat, vibration, etc., and then put into a case. In addition, the battery pack refers to a battery assembly that accommodates a preset number of battery modules to achieve a desired voltage or power.

In addition, the battery assembly according to the present disclosure may also refer to a battery pack having a cell to pack (CTP) structure, which generates the desired voltage or power by accommodating the preset number of battery cells without using the battery module.

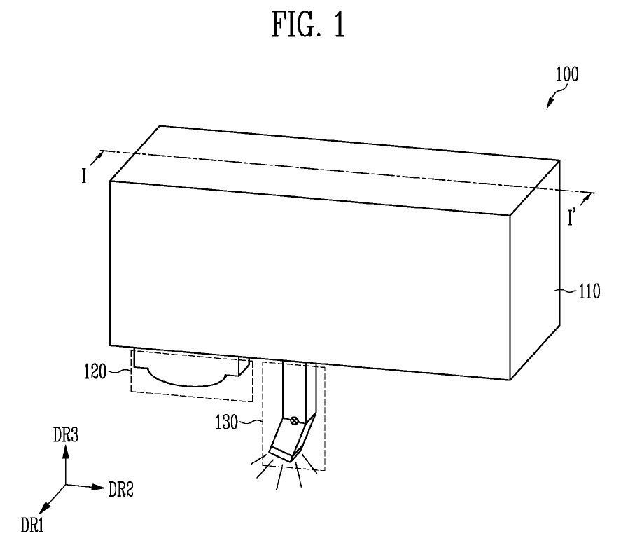

FIG. 1 is a perspective view illustrating a welding device according to first and second embodiments.

Referring to FIG. 1, a welding device 100 according to first and second embodiments may include a frame 110, a lens 120, and a lighting 130.

The frame 110 may have a three-dimensional shape extending in a first direction DR1, a second direction DR2 intersecting the first direction DR1, and a third direction DR3 intersecting both the first direction DR1 and the second direction DR2. For example, as illustrated in FIG. 1, the frame 110 may have a rectangular parallelepiped shape, but embodiments of the present disclosure are not necessarily limited thereto.

One surface (e.g., a bottom surface of the frame 110) of the frame 110 may be coupled to the lens 120. The lens 120 may perform a function of focusing laser beam emitted from the inside to the outside of the frame 110 so that the laser beam is accurately irradiated onto a desired area of the welding object. In addition, the lens 120 may also serve a function of providing a path through which light reflected from the welding object and incident into the frame 110 passes.

The lighting 130, which irradiates light toward the welding object, may be disposed on one surface (e.g., the bottom surface of the frame 110) of the frame 110 to which the lens 120 is coupled.

Light emitted from the lighting 130 may be reflected from the welding object and then incident into the frame 110 through the lens 120.

In embodiments of the present disclosure, the light emitted from the lighting 130 may be visible light, but this is merely an example, the light emitted from the lighting 130 may also be ultraviolet rays or infrared light.

The welding device 100 according to embodiments of the present disclosure may confirm an accurate welding position through a camera, and may irradiate the laser beam at an appropriate welding position on the basis of the information so that the welding is performed. The position and intensity of the laser beam may be adjusted according to the progress of the welding.

When using only one high-resolution camera, the precise welding position confirmation is possible, but an amount of data that needs to be processed increases, resulting in slower frame rate. As a result, it may be difficult to identify the welding position in real time. On the other hand, although a camera with low resolution may be used to identify the welding position in real time, it may be difficult to accurately confirm the welding position in this case. The welding device 100 according to embodiments of the present disclosure may more precisely evaluate a welding state and improve accuracy of selection of the welding position by cross-photographing the welding object using the plurality of cameras.

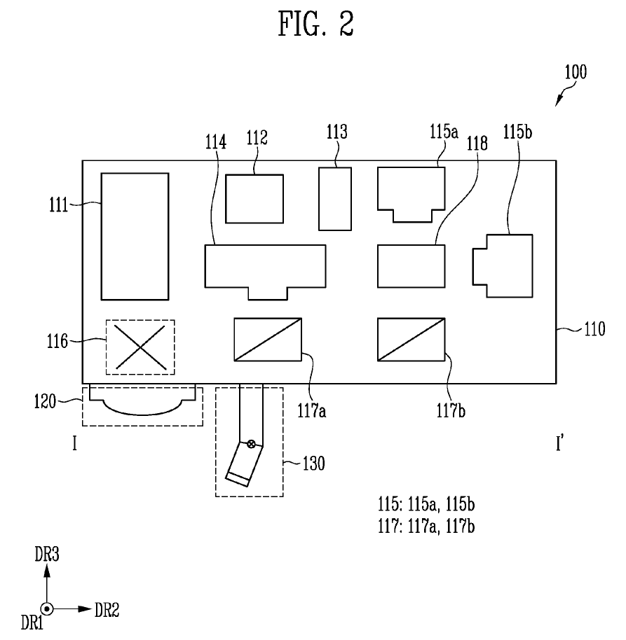

FIG. 2 is a cross-sectional view taken along line I-I’ of the welding device of FIG. 1 according to the first embodiment.

Referring to FIG. 2, the welding device 100 may include the frame 110, the lens 120, and the lighting 130. The descriptions of the lens 120 and the lighting 130 that overlap those given with reference to FIG. 1 will be omitted below.

The frame 110 forms an internal space, and a central controller 111, a data processing device 112, a data conversion device 113, a laser 114, the camera 115, a scanner 116, a mirror 117, and a beam splitter 118 may be disposed in the internal space of the frame 110.

The camera 115 may include a plurality of cameras. For example, the camera 115 may include a first camera 115a and a second camera 115b.

The mirror 117 may include a plurality of mirrors. For example, the mirror 117 may include a first mirror 117a and a second mirror 117b.

The central controller 111 may perform a function of controlling the data processing device 112, the laser 114, the scanner 116, and the lighting 130. For example, the central controller 111 may control an angle of the scanner 116 to adjust a direction of propagation of laser beam or light within the frame 110. For example, the central controller 111 may adjust an intensity, a wavelength, a phase, etc., of the laser beam emitted from the laser 114. For example, the central controller 111 may adjust an on/off operation of the lighting 130 to control the lighting 130 so as to emit light or so as not to emit light. Furthermore, the central controller 111 may control the data processing device 112 to transmit control signals (e.g., trigger signals) to the camera 115.

The data processing device 112 may supply the control signals (e.g., the trigger signals) to the camera 115 under the control of the central controller 111. In addition, the data processing device 112 may determine a welding state (e.g., a degree of progress of the welding, etc.) on the basis of information signals transmitted through the camera 115 and the data conversion device 113.

The data conversion device 113 may transmit the control signals (e.g., the trigger signals) supplied from the data processing device 112 to the camera 115. In addition, the data conversion device 113 may perform a function of processing images transmitted from the camera 115. For example, the data conversion device 113 may capture a still image from the images. For example, when the images are generated by an analog camera, the data conversion device 113 may convert the images into digital signals so that the digital signals are processed by a computer. For example, the data conversion device 113 may process an image transmitted from the camera 115 and then transmit the processed image to another device (e.g., the data processing device 112).

The laser 114 may emit laser beam having various wavelengths, intensities, and phases in response to the control of the central controller 111. For example, when it is necessary to increase in welding speed by evaluating the welding state of the welding object in real time, the intensity of the laser beam emitted from the laser 114 increases. The laser beam emitted from the laser 114 may be reflected by the first mirror 117a to move in a specific direction.

The camera 115 may receive light reflected from the welding object to generate images. The images may be used as data showing the welding state of the welding object. The first camera 115a may receive light reflected from the welding object to generate a first image. The second camera 115b may receive light reflected from the welding object to generate a second image. The images generated by the camera 115 may be transmitted to the data processing device 112 via the data conversion device 113 and may be used to evaluate the welding state in real time.

A period during which the first camera 115a generates the first image and a period during which the second camera 115b generates the second image may be separated from each other in time. More specifically, the period during which the first camera 115a generates the first image may be intersected with the period during which the second camera 115b generates the second image. While the first camera 115a generates the first image, the second camera 115b may not generate the second image, and while the second camera 115b generates the second image, the first camera 115a may not generate the first image.

The period during which the first camera 115a generates the first image may overlap a period during which the second camera 115b transmits the generated second image to the data processing device 112 and a period during which the second camera 115b is turned off.

Likewise, the period during which the second camera 115b generates the second image may overlap a period during which the first camera 115a transmits the generated first image to the data processing device 112 and a period during which the first camera 115a is turned off.

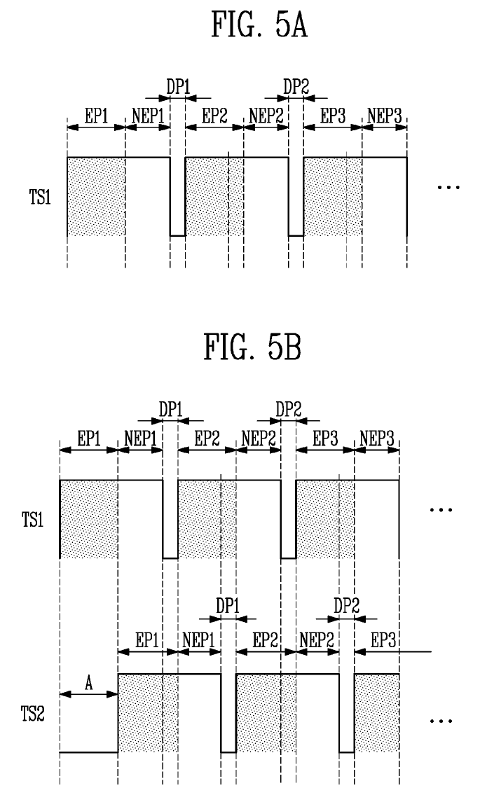

The welding device 100 according to the first embodiment of the present disclosure may cross-generate images by using the first camera 115a and the second camera 115b to double the frame rate compared to the case in which the image is generated using a single camera. For example, when the frame rate of each of the first camera 115a and the second camera 115b of the welding device 100 is about 30 Hz, the camera 115 may generate images at a frame rate of about 60 Hz. An effect of this welding device 100 will be described in detail with reference to FIGS. 5A and 5B.

The scanner 116 may be controlled by the central controller 111 to adjust the traveling direction of the laser beam transmitted from the first mirror 117a so that the laser beam is accurately irradiated onto a desired area of the welding object. In addition, the scanner 116 may adjust the traveling direction of the light reflected from the welding object so that the light is accurately transmitted to the camera 115 via the first mirror 117a and the second mirror 117b.

In embodiments, the scanner 116 may reflect the laser beam and the light reflected from the welding object in a desired direction of the laser beam the light. However, the embodiments of the present disclosure are not necessarily limited thereto. The scanner 116 may adjust the traveling direction of the laser beam and the light reflected from the laser and the welding object in various manners.

The mirrors included in the mirror 117 may be dichroic mirrors that reflect light having a specific wavelength and transmit light having another wavelength through special coating. The first mirror 117a may reflect the laser beam emitted from the laser 114 and transmit the reflected laser beam to the scanner 116. On the other hand, the first mirror 117a may allow the light reflected from the welding object and transmitted through the lens 120 and the scanner 116 to pass without being blocked. The light that has passed through the first mirror 117a may be reflected by the second mirror 117b and transmitted to the beam splitter 118.

The beam splitter 118 may separate the light transmitted from the second mirror 117b and transmit the separated light to each of the first camera 115a and the second camera 115b. The light separated by the beam splitter 118 may have the same property. For example, the phase of the light transmitted from the beam splitter 118 to the first camera 115a may be the same as the phase of the light transmitted from the beam splitter 118 to the second camera 115b.

Although FIG. 2 illustrates that the light paths separated from the beam splitter 118 intersect each other, the embodiments of the present disclosure are not necessarily limited thereto.

During the welding process using the welding device 100, the first camera 115a and the second camera 115b receive the same light from the beam splitter 118. While the first camera 115a generates the first image using the received light, the second camera 115b may transmit the generated second image to the data processing device 112 or may be in a turned-off state (or operation stop state). Conversely, while the second camera 115b generates the second image using the received light, the first camera 115a may transmit the generated first image to the data processing device 112 or may be in a turned-off state (or operation stop state). As a result, the first image and the second image show an appearance of the welding object at different time periods to allow for continuous observation of the appearance of the welding object.

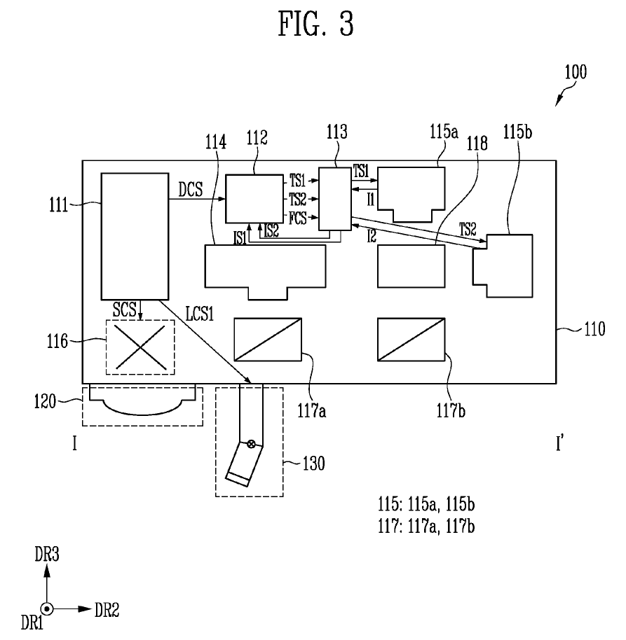

FIG. 3 is a view for explaining a flow of a signal transmitted and received between components of the welding device of FIG. 2.

Referring to FIGS. 2 and 3, the welding device 100 may include the laser 114 that irradiates laser beam having a first wavelength toward the welding object, the lighting 130 that irradiates light having a second wavelength different from the first wavelength onto a laser-irradiated area of the welding object, the first camera 115a that receives the light having the second wavelength reflected from the welding object and generates the first image, and the second camera 115b that receives the light having the second wavelength reflected from the welding object and generates the second image.

In addition, the welding device 100 may include the beam splitter 118 that separates the light having the second wavelength reflected from the welding object and transmits the light to each of the first camera 115a and the second camera 115b, the scanner 116 that adjusts the traveling directions of the laser and the light having the second wavelength reflected from the welding object, and the first mirror 117a that receives the laser beam from the laser 114 and transmits the laser beam to the scanner 116, and the second mirror 117b that receives the light having the second wavelength from the scanner 116 and transmits the light to the beam splitter 118.

The central controller 111 may perform a role of managing and controlling an operation of the data processing device 112, the laser 114, the scanner 116, and the lighting 130. For example, the central controller 111 may transmit a data control signal DCS to the data processing device 112 to control the data processing device 112, thereby transmitting control signals (e.g., a first trigger signal TS1, a second trigger signal TS2, and a data conversion device control signal FCS) to the data conversion device 113. For example, the central controller 111 may transmit the scanner control signal SCS to the scanner 116 to control an angle of the scanner 116, etc. For example, the central controller 111 may transmit a first lighting control signal LCS1 to the lighting 130 to control the on/off of the lighting 130 and may control whether the lighting 130 emits the light having the second wavelength. For example, the central controller 111 may control the laser 114 to adjust an intensity, a wavelength, a phase, etc., of the laser beam emitted from the laser 114.

The data processing device 112 may generate and supply, to the data conversion device 113, the data conversion device control signal FCS, the first trigger signal TS1, and the second trigger signal TS2 under the control of the central controller 111. The first trigger signal TS1, which is a signal for controlling the operation of the first camera 115a, may be supplied to the first camera 115a via the data conversion device 113. The second trigger signal TS2, which is a signal for controlling the operation of the second camera 115b, may be supplied to the second camera 115b via the data conversion device 113. The operation of the first camera 115a and the second camera 115b according to the first trigger signal TS1 and the second trigger signal TS2 will be described later with reference to FIG. 5B.

The first image I1 generated by the first camera 115a and the second image I2 generated by the second camera 115b may be transmitted to the data conversion device 113, respectively. The data conversion device 113 may generate a first information signal IS1 by converting the first image I1 to match a format of the data processing device 112 so that the data processing device 112 uses the first information signal IS1 to recognize the welding state (e.g., the degree of welding progress). The data conversion device 113 may generate a second information signal IS2 by converting the second image I2 to match the format of the data processing device 112. The generated first and second information signals IS1 and IS2 are transmitted to the data processing device 112, and the data processing device 112 may determine the welding state on the basis of the transmitted first and second information signals IS1 and IS2.

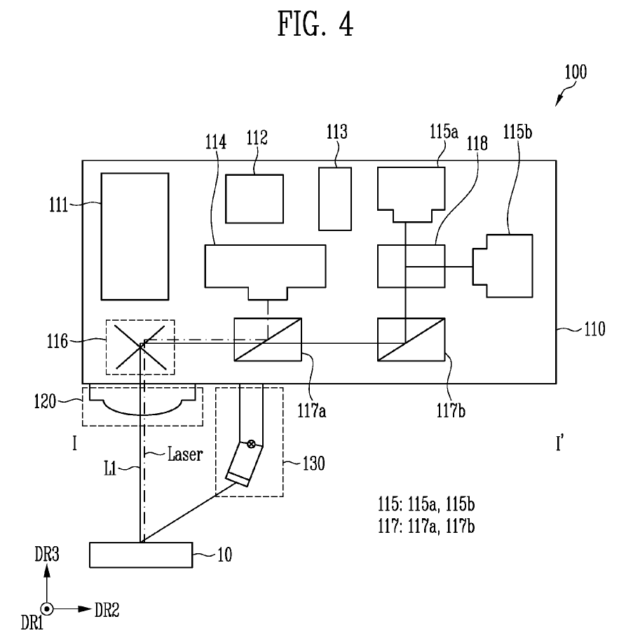

FIG. 4 is a view for explaining a path through which the laser beam and the light having the second wavelength within the welding device of FIG. 2.

Referring to FIGS. 2 and 4, the laser beam having the first wavelength, which is emitted from the laser 114, may be reflected by the first mirror 117a and transmitted to the scanner 116. Thereafter, the laser beam may be reflected again from the scanner 116 and then accurately irradiated onto a desired area of the welding object 10 via the lens 120.

Light L1 having the second wavelength, which is emitted from the lighting 130, may be reflected from the welding object 10 and transmitted to the scanner 116 via the lens 120. Here, the second wavelength may be in a range of about 400 nm to about 700 nm, but embodiments of the present disclosure are not necessarily limited thereto. Here, the second wavelength may be different from the first wavelength.

Thereafter, the light L1 having the second wavelength may be reflected again from the scanner 116, pass through the first mirror 117a, and be transmitted to the second mirror 117b. Thereafter, the light L1 having the second wavelength may be reflected by the second mirror 117b and separated by the beam splitter 118 and then may be transmitted to the first camera 115a and the second camera 115b.

The light L1 having the second wavelength, which is separated at the beam splitter 118 and transmitted to the first camera 115a and the second camera 115b, may have the same property. For example, the light L1 having the second wavelength, which is separated by the beam splitter 118 and transmitted to the first camera 115a and the second camera 115b, may have the same phase.

FIGS. 5A and 5B are timing views for explaining an effect of the welding device of FIG. 2. FIG. 5B is a timing diagram illustrating a first trigger signal TS1 and a second trigger signal TS2, which are supplied to the first camera 115a and the second camera 115b in the welding device 100 according to the first embodiment. On the other hand, FIG. 5A is a timing diagram illustrating the first trigger signal TS1 supplied to the camera in the case in which the welding device includes one camera.

Referring to FIG. 5A, the first trigger signal TS1 may be in the form of a pulse. When the first trigger signal TS1 is at a high level, the single camera may receive light reflected from the welding object to generate an image and may transmit the generated image to the data processing device 112. When the first trigger signal TS1 is at a low level, the single camera may be turned off to stop operating.

First to third effective periods EP1 to EP3 may correspond to periods during which the single camera generates images. In addition, first to third non-effective periods NEP1 to NEP3 may correspond to periods during which the single camera transmits the generated images to the data processing device 112. In addition, the first and second turn-off periods DP1 and DP2 may correspond to periods during which the single camera is turned off to stop operating.

In the first effective period EP1, the single camera may receive the light reflected from the welding object to generate an image. In the subsequent first non-effective period NEP1, the generated image may be transmitted to the data processing device 112. In the subsequent first turn-off period DP1, the single camera may be turned off.

In the second effective period EP2, the single camera may receive the light reflected from the welding object to generate an image. In the subsequent second non-effective period NEP2, the generated image may be transmitted to the data processing device 112. In the subsequent second turn-off period DP2, the single camera may be turned off.

In the third effective period EP3, the single camera may receive the light reflected from the welding object to generate an image. In the subsequent third non-effective period NEP3, the generated image may be transmitted to the data processing device 112. In this manner, the single camera may receive the light reflected from the welding object to generate an image and may transmit the image to the data processing device 112.

Referring to FIG. 5B, the first trigger signal TS1 may be supplied to the first camera 115a to function as a control signal, and the second trigger signal TS2 may be supplied to the second camera 115b to function as a control signal.

Each of the first trigger signal TS1 and the second trigger signal TS2 may be in the form of a pulse. As illustrated in FIG. 5B, each of the first trigger signal TS1 and the second trigger signal TS2 may have the form of a square pulse, but embodiments of the present disclosure are not necessarily limited thereto.

When the first trigger signal TS1 is at a high level, the first camera 115a may generate the first image and may transmit the generated first image to the data processing device 112. When the first trigger signal TS1 is at a low level, the first camera 115b may be turned off.

When the second trigger signal TS2 is at a high level, the second camera 115b may generate the second image and may transmit the generated second image to the data processing device 112. When the second trigger signal TS2 is at a low level, the second camera 115b may be turned off.

In the first trigger signal TS1, the first to third effective periods EP1 to EP3 may correspond to periods during which the first camera 115a generates the first images. In addition, the first to third non-effective periods NEP1 to NEP3 in the first trigger signal TS1 may correspond to periods during which the first camera 115a transmits the first images generated by the first camera 115a to the data processing device 112. In addition, the first and second turn-off periods DP1 and DP2 in the first trigger signal TS1 may correspond to periods during which the first camera 115a is turned off to stop operating.

In the first effective period EP1 of the first trigger signal TS1, the first camera 115a may receive the light reflected from the welding object to generate the first image. In the subsequent first non-effective period NEP1, the generated first image may be transmitted to the data processing device 112. In the subsequent first turn-off period DP1, the first camera 115a may be turned off.

In the second effective period EP2 of the first trigger signal TS1, the first camera 115a may receive the light reflected from the welding object to generate the first image. In the following second non-effective period NEP2, the generated first image may be transmitted to the data processing device 112. In the subsequent second turn-off period DP2, the first camera 115a may be turned off.

In the third effective period EP3 of the first trigger signal TS1, the first camera 115a may receive the light reflected from the welding object to generate the first image. In the subsequent third non-effective period NEP3, the generated first image may be transmitted to the data processing device 112. In this manner, the first camera 115a may receive the light reflected from the welding object to generate the first image and may transmit the first image to the data processing device 112.

In the second trigger signal TS2, the first to third effective periods EP1 to EP3 may correspond to periods during which the second camera 115b generates the second images. In addition, the first to third non-effective periods NEP1 to NEP3 in the second trigger signal TS2 may correspond to periods during which the second camera 115b transmits the second images generated therefrom to the data processing device 112. In addition, in the second trigger signal TS2, the first and second turn-off periods DP1 and DP2 may correspond to periods during which the second camera 115b is turned off to stop operating.

In the first effective period EP1 of the second trigger signal TS2, the second camera 115b may receive the light reflected from the welding object to generate the second image. In the subsequent first non-effective period NEP1, the generated second image may be transmitted to the data processing device 112. In the subsequent first turn-off period DP1, the second camera 115b may be turned off.

In the second effective period EP2 of the second trigger signal TS2, the second camera 115b may receive the light reflected from the welding object to generate the second image. In the subsequent second non-effective period NEP2, the generated second image may be transmitted to the data processing device 112. In the subsequent second turn-off period DP2, the second camera 115b may be turned off.

In the third effective period EP3 of the second trigger signal TS2, the second camera 115b may receive the light reflected from the welding object to generate the second image. In the subsequent third non-effective period NEP3, the generated second image may be transmitted to the data processing device 112. In this manner, the second camera 115b may receive the light reflected from the welding object to generate the second image and may transmit the second image to the data processing device 112.

The generation period of the second image may overlap the transmission period to the data processing device 112 of the first image and the turn-off period of the first camera 115a. For example, the first effective period EP1 of the second trigger signal TS2 may overlap the first non-effective period NEP1 and the first turn-off period DP1 of the first trigger signal TS1.

Likewise, the generation period of the first image may overlap the transmission period to the data processing device 112 of the second image and the turn-off period of the second camera 115b. For example, the second effective period EP2 of the first trigger signal TS1 may overlap the first non-effective period NEP1 and the first turn-off period DP1 of the second trigger signal TS2.

The second trigger signal TS2 may be in a form that is delayed by as much as a length of the generation period of the first image with respect to the first trigger signal TS1. More specifically, the second trigger signal TS2 may be in a form that is delayed by as much as A, which is a length of the first effective period EP1 of the first trigger signal TS1.

In the first embodiment, the length of the generation period of the first image and the length of the transmission period of the first image may be the same. For example, the lengths of the first effective period EP1 and the first non-effective period NEP1 may be the same. For example, the lengths of the second effective period EP2 and the second non-effective period NEP2 may be the same. However, the embodiments of the present disclosure are not necessarily limited thereto.

Comparing FIGS. 5A and 5B, since the welding device 100 includes two cameras, the number of images generated within the same time period may be doubled compared to the case in which the single camera is used. More specifically, when the welding device uses the single camera to generate three images, the welding device 100 may generate six images to improve the frame rate. When the camera included in the welding device 100 supports high resolution, precise confirmation of the welding position is possible. Furthermore, the welding object may be by cross-photographed using the plurality of cameras, the frame rate may increase.

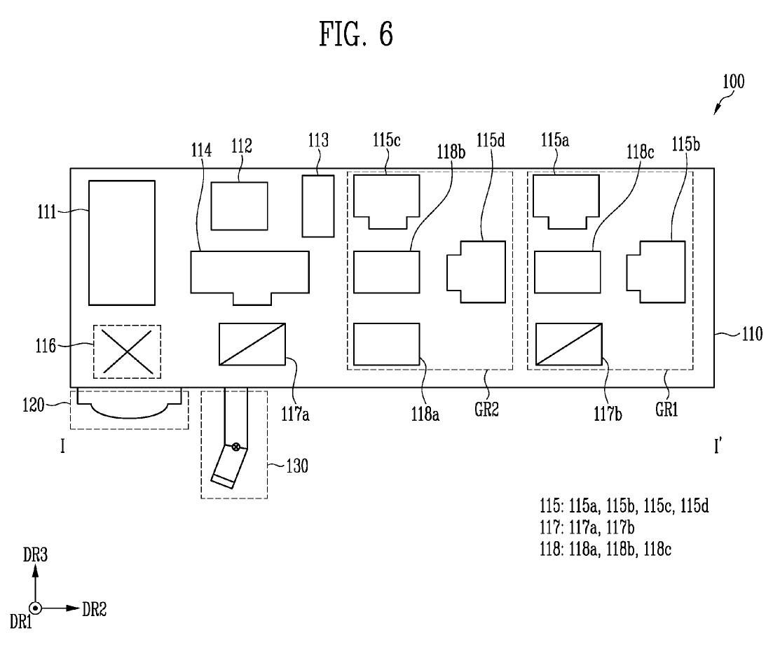

FIG. 6 is a cross-sectional view taken along line I-I’ of the welding device of FIG. 1 according to a second embodiment.

Referring to FIG. 6, the welding device 100 may include a frame 110, a lens 120, and a lighting 130. The descriptions of the lens 120 and the lighting 130 that overlap those given with reference to FIG. 1 will be omitted below.

The frame 110 forms an internal space, and a central controller 111, a data processing device 112, a data conversion device 113, a laser 114, the camera 115, a scanner 116, a mirror 117, and a beam splitter 118 may be disposed in the internal space of the frame 110.

The camera 115 may include a plurality of cameras. For example, the camera 115 may include a first camera 115a to a fourth camera 115d.

The mirror 117 may include a plurality of mirrors. For example, the mirror 117 may include a first mirror 117a and a second mirror 117b.

The beam splitter 118 may be provided in plurality, and the welding device 100 may include first to third beam splitters 118a to 118c.

The second embodiment is characterized in that the third mirror 115c, the fourth mirror 115d, the first beam splitter 118a, and the second beam splitter 118b are added compared to the first embodiment described with reference to FIG. 2. The third beam splitter 118c of FIG. 6 may correspond to the beam splitter 118 of FIG. 2. The description that overlaps that of FIG. 2 is omitted below.

The camera 115 may generate images by recognizing light reflected from the welding object. The images may be used as data showing the state of the welding object. The first camera 115a may receive the light reflected from the welding object to generate a fifth image. The second camera 115b may receive the light reflected from the welding object to generate a sixth image. The third camera 115c may receive the light reflected from the welding object to generate a third image. The fourth camera 115d may receive the light reflected from a welding object to generate a fourth image. The images generated by the camera 115 may be transmitted to the data processing device 112 via the data conversion device 113 and may be used to evaluate the welding state in real time.

The period during which the first camera 115a generates the fifth image, the period during which the second camera 115b generates the sixth image, the period during which the third camera 115c generates the third image, and the period during which the fourth camera 115d generates the fourth image may be separated from each other in time. More specifically, the period during which the first camera 115a generates the fifth image, the period during which the second camera 115b generates the sixth image, the period during which the third camera 115c generates the third image, and the period during which the fourth camera 115d generates the fourth image may be sequentially repeated without overlapping each other.

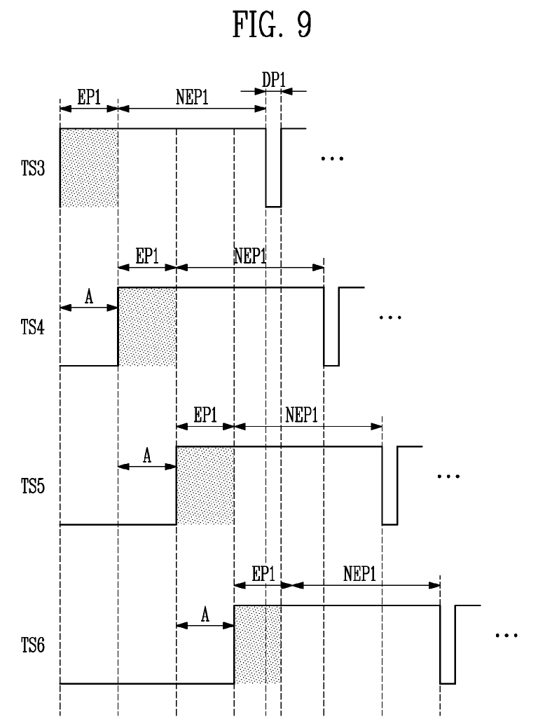

The welding device 100 according to the second embodiment of the present disclosure may sequentially generate the images so that the images do not overlap each other by using the first camera 115a to the fourth camera 115d, thereby improving a frame rate four times compared to the case in which an image is generated using only one camera. For example, when the frame rate of each of the first camera 115a to the fourth camera 115d of the welding device 100 is about 30 Hz, the camera 115 may generate the images at a frame rate of about 120 Hz. The effects of this welding device 100 will be described in detail with reference to FIG. 9.

The first mirror 117a may reflect the laser beam emitted from the laser 114 and transmit the reflected laser beam to the scanner 116. On the other hand, the first mirror 117a may allow the light reflected from the welding object and transmitted through the lens 120 and the scanner 116 to pass without being blocked.

The first beam splitter 118a may separate light transmitted from the first mirror 117a and transmit the separated light to each of the second beam splitter 118b and the second mirror 117b. The light separated by the first beam splitter 118a may have the same property. For example, the phases of the light transmitted from the first beam splitter 118a to the second beam splitter 118b and the second mirror 117b may be the same.

Although FIG. 6 illustrates light paths of light separated from the first beam splitter 118a intersect each other, the embodiments of the present disclosure are not necessarily limited thereto.

The second beam splitter 118b may separate light transmitted from the first beam splitter 118a and transmit the separated light to the third camera 115c and the fourth camera 115d, respectively. The light separated by the second beam splitter 118b may have the same property. For example, the phase of the light transmitted from the second beam splitter 118b to the third camera 115c may be the same as the phase of the light transmitted from the second beam splitter 118b to the fourth camera 115d.

Although FIG. 6 illustrates that the light paths separated from the beam splitter 118 intersect each other, the embodiments of the present disclosure are not necessarily limited thereto.

In the welding process using the welding device 100, the first camera 115a to the fourth camera 115d receive light having the same property, respectively. However, the period during which the first camera 115a generates the fifth image, the period during which the second camera 115b generates the sixth image, the period during which the third camera 115c generates the third image, and the period during which the fourth camera 115d generates the fourth image may be sequentially repeated without overlapping each other. As a result, the first to fourth images show an appearance of the welding object at different time periods to allow for continuous observation of the appearance of the welding object.

The first camera 115a, the second camera 115b, the third beam splitter 118c, and the second mirror 117b may form a first group GR1. The third camera 115c, the fourth camera 115d, the first beam splitter 118a, and the second beam splitter 118b may form a second group GR2. According to an embodiment, if the welding device 100 further includes a beam splitter and a camera, the frame rate of the camera 115 may be further improved. For example, a configuration that is identical to that of the second group GR2 may be additionally disposed between the first group GR1 and the second group GR2, the frame rate may increase, and the welding state may be more precisely determined.

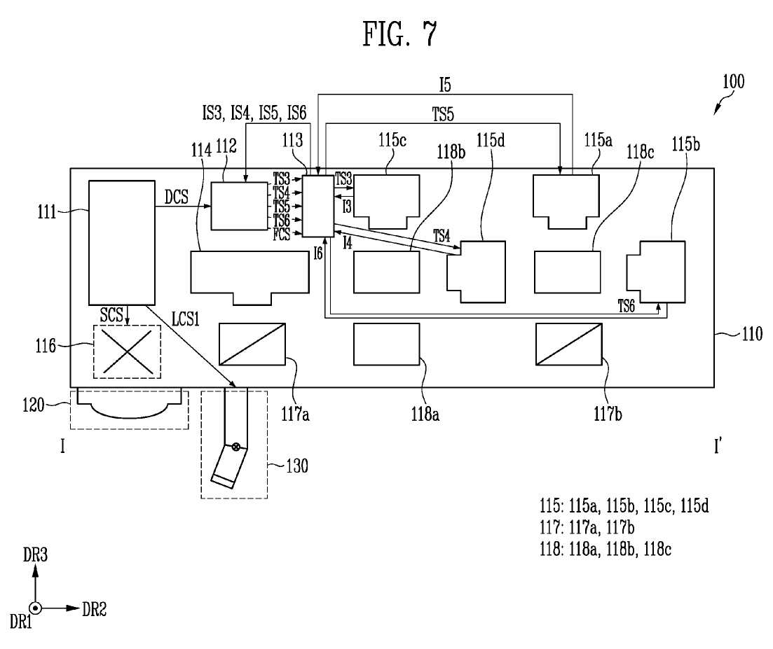

FIG. 7 is a view for explaining a flow of a signal transmitted and received between components of the welding device of FIG. 6. The second embodiment is characterized in that the third mirror 115c, the fourth mirror 115d, the first beam splitter 118a, and the second beam splitter 118b are added compared to the first embodiment described with reference to FIG. 3. The third beam splitter 118c of FIG. 7 may correspond to the beam splitter 118 of FIG. 3. The description that overlaps that of FIG. 3 is omitted below.

Referring to FIGS. 6 and 7, the data processing device 112 may generate and supply a data conversion device control signal FCS and third to sixth trigger signals TS3 to TS6 to the data conversion device 113 under the control of the central controller 111.

The third trigger signal TS3, which is a signal for controlling an operation of the third camera 115c, may be supplied to the third camera 115c via the data conversion device 113.

The fourth trigger signal TS4, which is a signal for controlling an operation of the fourth camera 115d, may be supplied to the fourth camera 115d via the data conversion device 113.

The fifth trigger signal TS5, which is a signal for controlling an operation of the first camera 115a, may be supplied to the first camera 115a via the data conversion device 113.

The sixth trigger signal TS6, which is a signal for controlling an operation of the second camera 115b, may be supplied to the second camera 115b via the data conversion device 113.

The operations of the first to fourth cameras 115a to 115d according to the third trigger signal TS3 and the sixth trigger signals TS6 will be described later with reference to FIG. 9.

Each of the fifth image I5 generated by the first camera 115a, the sixth image I6 generated by the second camera 115b, the third image I3 generated by the third camera 115c, and the fourth image I4 generated by the fourth camera 115d may be transmitted to the data conversion device 113. The data conversion device 113 may generate a fifth information signal IS5 by converting the fifth image I5 to match a format of the data processing device 112 so that the data processing device 112 uses the fifth information signal IS5 to recognize the welding state of the welding object. The data conversion device 113 may generate a sixth information signal IS6 by converting the sixth image I6 to match the format of the data processing device 112. The data conversion device 113 may generate third information signal IS3 by converting the third image I3 to match the format of the data processing device 112. The data conversion device 113 may generate a fourth information signal IS4 by converting the fourth image I4 to match the format of the data processing device 112. The generated third to sixth information signals IS3 to IS6 are transmitted to the data processing device 112, and the data processing device 112 may determine the welding state on the basis of the transmitted third to sixth information signals IS3 to IS6.

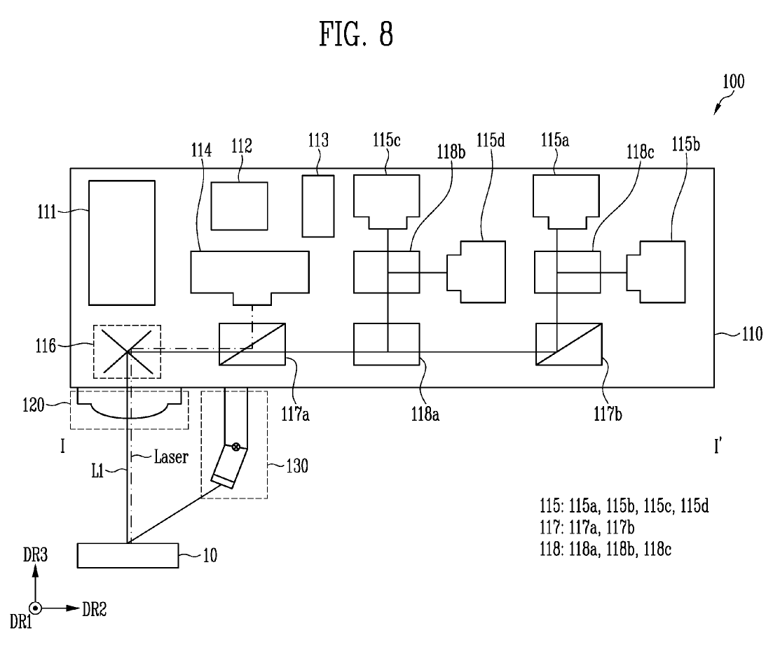

FIG. 8 is a view for explaining a path through which laser beam and light having a second wavelength within the welding device of FIG. 6. The second embodiment is characterized in that the third mirror 115c, the fourth mirror 115d, the first beam splitter 118a, and the second beam splitter 118b are added compared to the first embodiment described with reference to FIG. 4. The third beam splitter 118c of FIG. 8 may correspond to the beam splitter 118 of FIG. 4. The description that overlaps that of FIG. 4 is omitted below.

Referring to FIGS. 6 and 8, the laser beam having the first wavelength, which is emitted from the laser 114, may be reflected by the first mirror 117a and transmitted to the scanner 116. Thereafter, the laser beam may be reflected again from the scanner 116 and then accurately irradiated onto a desired area of the welding object 10 via the lens 120.

Light L1 having the second wavelength, which is emitted from the lighting 130, may be reflected from the welding object 10 and transmitted to the scanner 116 via the lens 120. Here, the second wavelength may be in a range of about 400 nm to about 700 nm, but embodiments of the present disclosure are not necessarily limited thereto.

Thereafter, the light L1 having the second wavelength may be reflected again from the scanner 116, pass through the first mirror 117a, and be transmitted to the first beam splitter 118a.

A portion of the light L1 having the second wavelength separated by the first beam splitter 118a may be transmitted to the second beam splitter 118b and may be further separated by the second beam splitter 118b to be transmitted to the third camera 115c and the fourth camera 115d.

A remaining portion of the light L1 having the second wavelength separated by the first beam splitter 118a may be reflected by the second mirror 117b and transmitted to the third beam splitter 118c and then be separated again by the third beam splitter 118c and transmitted to the first camera 115a and the second camera 115b.

FIG. 9 is a timing view for explaining an effect of the welding device of FIG. 6. FIG. 9 is a timing diagram illustrating the third to sixth trigger signals TS3 to TS6 supplied to the first to fourth cameras 115a to 115d in the welding device 100 according to the second embodiment.

Referring to FIGS. 6 and 9, the third trigger signal TS3 may be supplied to the third camera 115c to function as a control signal, and the fourth trigger signal TS4 may be supplied to the fourth camera 115d to function as a control signal. The fifth trigger signal TS5 may be supplied to the first camera 115a to function as a control signal, and the sixth trigger signal TS6 may be supplied to the second camera 115b to function as a control signal.

Each of the third trigger signal TS3 to the sixth trigger signal TS6 may be in the form of a pulse. As illustrated in FIG. 9, each of the third trigger signal TS3 to the sixth trigger signal TS6 may have a square pulse shape, but embodiments of the present disclosure are not necessarily limited thereto.

When the third trigger signal TS3 is at a high level, the third camera 115c may generate the third image and may transmit the generated third image to the data processing device 112. When the third trigger signal TS3 is at a low level, the third camera 115c may be turned off (or its operation is stopped).

When the fourth trigger signal TS4 is at a high level, the fourth camera 115d may generate the fourth image and may transmit the generated fourth image to the data processing device 112. When the fourth trigger signal TS4 is at a low level, the fourth camera 115d may be turned off (or its operation is stopped).

When the fifth trigger signal TS5 is at a high level, the first camera 115a may generate the fifth image and may transmit the generated fifth image to the data processing device 112. When the fifth trigger signal TS5 is at a low level, the first camera 115a may be turned off (or its operation is stopped).

When the sixth trigger signal TS6 is at a high level, the second camera 115b may generate the sixth image and may transmit the generated sixth image to the data processing device 112. When the sixth trigger signal TS6 is at a low level, the second camera 115b may be turned off (or its operation is stopped).

In the third trigger signal TS3, the first effective period EP1 may correspond to a period during which the third camera 115c generates the third image. In addition, the first non-effective period NEP1 in the third trigger signal TS3 may correspond to a period during which the third camera 115c transmits the third image generated by the third camera 115c to the data processing device 112. In the third trigger signal TS3, the first turn-off period DP1 may correspond to a period during which the third camera 115c is turned off to stop operating.

In the fourth trigger signal TS4, the first effective period EP1 may correspond to a period during which the fourth camera 115d generates the fourth image. In the fourth trigger signal TS4, the first non-effective period NEP1 may correspond to a period during which the fourth camera 115d transmits the fourth image generated by the fourth camera 115d to the data processing device 112. In the fourth trigger signal TS4, the first turn-off period DP1 may correspond to a period during which the fourth camera 115d is turned off to stop operating.

In the fifth trigger signal TS5, the first effective period EP1 may correspond to a period during which the first camera 115a generates the fifth image. In the fifth trigger signal TS5, the first non-effective period NEP1 may correspond to a period during which the first camera 115a transmits the fifth image generated by the first camera 115a to the data processing device 112. In the fifth trigger signal TS5, the first turn-off period DP1 may correspond to a period during which the first camera 115a is turned off to stop operating.

In the sixth trigger signal TS6, the first effective period EP1 may correspond to a period during which the second camera 115b generates the sixth image. In the sixth trigger signal TS6, the first non-effective period NEP1 may correspond to a period during which the second camera 115b transmits the sixth image generated by the second camera 115b to the data processing device 112. In the sixth trigger signal TS6, the first turn-off period DP1 may correspond to a period during which the second camera 115b is turned off to stop operating.

The periods during which the third to sixth images are generated may be sequentially repeated without overlapping each other. For example, the first effective period EP1 of the third trigger signal TS3, the first effective period EP1 of the fourth trigger signal TS4, the first effective period EP1 of the fifth trigger signal TS5, and the first effective period EP1 of the sixth trigger signal TS6 may be sequentially repeated without overlapping each other.

The fourth trigger signal TS4 may be in a form that is delayed by as much as a length of the generation period of the third image with respect to the third trigger signal TS3. More specifically, the fourth trigger signal TS4 may be in a form that is delayed by as much as A, which is a length of the first effective period EP1 of the third trigger signal TS3.

The fifth trigger signal TS5 may be in a form that is delayed by as much as a length of the generation period of the fourth image with respect to the fourth trigger signal TS4. More specifically, the fifth trigger signal TS5 may be in a form that is delayed by as much as A, which is the length of the first effective period EP1 of the fourth trigger signal TS4.

The sixth trigger signal TS6 may be in a form that is delayed by as much as the length of the generation period of the first image with respect to the fifth trigger signal TS5. More specifically, the sixth trigger signal TS6 may be in a form that is delayed by as much as A, which is the length of the first effective period EP1 of the fifth trigger signal TS5.

The first effective period EP1 of the sixth trigger signal TS6 may overlap the first non-effective period NEP1 and the first turn-off period DP1 of the third trigger signal TS3.

Compared to when the welding device 100 uses the single camera, since the welding device 100 includes four cameras, the number of generated images may increase by four times. When the camera included in the welding device 100 supports high resolution, precise confirmation of the welding position is possible. Furthermore, the welding object may be by cross-photographed using the plurality of cameras, the frame rate may increase.

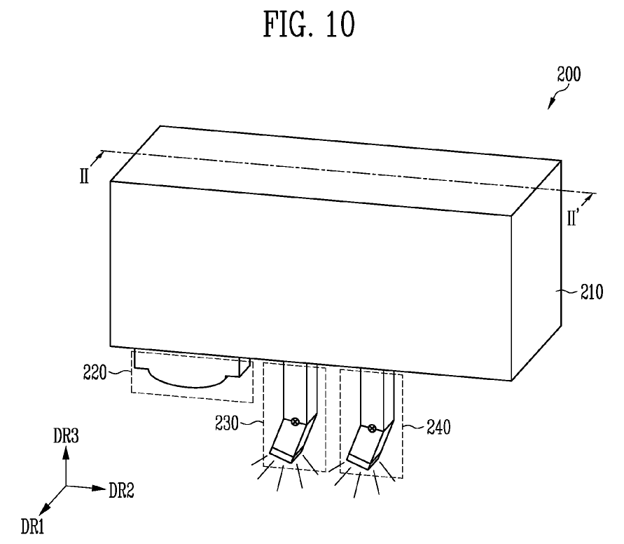

FIG. 10 is a perspective view illustrating a welding device according to third and fourth embodiments.

Referring to FIG. 10, the welding device 200 according to the third and fourth embodiments may include a frame 210, a lens 220, a first lighting 230, and a second lighting 240.

The frame 210 may have a three-dimensional shape extending in a first direction DR1, a second direction DR2 intersecting the first direction DR1, and a third direction DR3 intersecting both the first direction DR1 and the second direction DR2. For example, as illustrated in FIG. 10, the frame 210 may have a rectangular parallelepiped shape, but embodiments of the present disclosure are not necessarily limited thereto.

One surface (e.g., a bottom surface of the frame 210) of the frame 210 may be coupled to the lens 220. The lens 220 may perform a function of focusing laser beam emitted from the inside to the outside of the frame 210 so that the laser beam is accurately irradiated onto a desired area of the welding object. In addition, the lens 220 may also serve a function of providing a path through which light reflected from the welding object and incident into the frame 210 passes.

A first lighting 230 and a second lighting 240, which irradiate light toward a welding object, may be disposed on one surface (e.g., a bottom surface of the frame 210) of the frame 210 to which the lens 220 is coupled.

Light emitted from the first lighting 230 and the second lighting 240 may be reflected from the welding object and then incident into the frame 210 through the lens 220.

In embodiments of the present disclosure, the light emitted from each of the first lighting 230 and the second lighting 240 may be visible light, but this is merely an example. The light emitted from the first lighting 230 and the second lighting 240 may also be ultraviolet ray or infrared light.

According to embodiments, the first lighting 230 and the second lighting 240 may emit light having the same wavelength.

According to embodiments, the first lighting 230 and the second lighting 240 may irradiate light having different wavelengths onto the welding object. For example, the first lighting 230 may irradiate light having a wavelength in a range of about 400 nm to 700 nm onto the welding object, whereas the second lighting 240 may irradiate light having a wavelength in a range of about 10 nm to about 400 nm onto the welding object. In other words, in the third embodiment, the first lighting 230 may irradiate light in the form of visible light onto the welding object, whereas the second lighting 240 may irradiate light in the form of ultraviolet ray onto the welding object. However, the embodiments of the present disclosure are not necessarily limited thereto, and the first lighting 230 may irradiate light in the form of ultraviolet ray onto the welding object, but the second lighting 240 may irradiate light in the form of visible light onto the welding object.

The welding device 200 according to embodiments of the present disclosure may confirm an accurate welding position through a camera, and may irradiate the laser beam at an appropriate welding position on the basis of the information so that the welding is performed. The position and intensity of the laser beam may be adjusted according to the progress of the welding.

According to the third embodiment of the present disclosure, the welding device 200 may generate an image of the welding object observed with light having various wavelengths by using the lightings having different wavelength bands and the cameras that recognize the lightings and may accurately evaluate the welding state on the basis of the image.

According to the fourth embodiment of the present disclosure, the plurality of cameras may be used to set different photographing areas for the welding object and simultaneously photograph images thereof to secure a wider viewing angle with respect to the welding object.

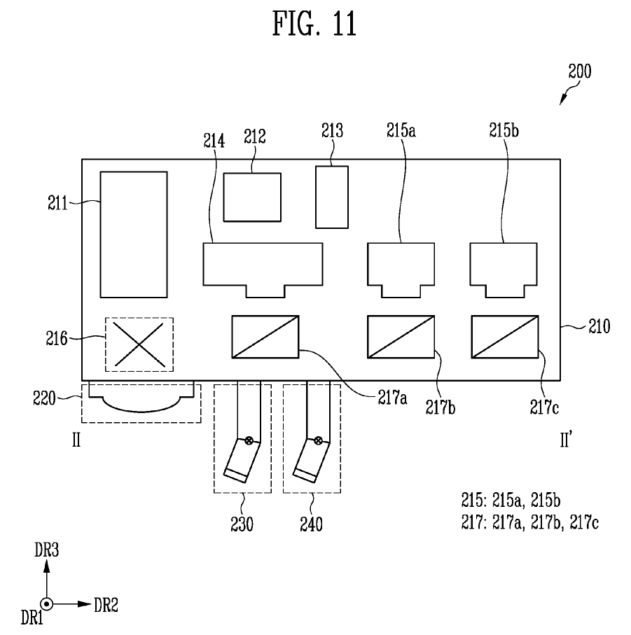

FIG. 11 is a cross-sectional view taken along line II-II’ of the welding device of FIG. 10.

Referring to FIGS. 10 and 11, the welding device 200 may include a frame 210, a lens 220, a first lighting 230, and a second lighting 240. The descriptions of the lens 220, the first lighting 230, and the second lighting 240 that overlap those given with reference to FIG. 10 will be omitted below.

The frame 210 forms an internal space, and a central controller 211, a data processing device 212, a data conversion device 213, a laser 214, a camera 215, a scanner 216, and a mirror 217 may be disposed in the internal space of the frame 210.

The camera 215 may include a plurality of cameras. For example, the camera 215 may include a first camera 215a and a second camera 215b.

The mirror 217 may include a plurality of mirrors. For example, the mirror 217 may include a first mirror 217a, a second mirror 217b, and a third mirror 217c.

The central controller 211 may perform a function of controlling the data processing device 212, the laser 214, the scanner 216, the first lighting 230, and the second lighting 240. For example, the central controller 211 may control an angle of the scanner 216 to adjust a traveling direction of laser beam or light within the frame 210. For example, the central controller 211 may adjust an intensity, a wavelength, a phase, etc., of the laser beam emitted from the laser 214. For example, the central controller 211 may adjust an on/off operation of the first lighting 230 to control the first lighting 230 so as to emit light or so as not to emit light. For example, the central controller 211 may adjust an on/off operation of the second lighting 240 to control the second lighting 240 so as to emit light or so as not to emit light. Furthermore, the central controller 211 may control the data processing device 212 to transmit control signals (e.g., trigger signals) to the camera 215.

The data processing device 212 may supply the control signals (e.g., the trigger signals) to the camera 215 under the control of the central controller 211. In addition, the data processing device 212 may determine a welding state on the basis of information signals transmitted through the camera 215 and the data conversion device 213.

The data conversion device 213 may transmit the control signals (e.g., the trigger signals) supplied from the data processing device 212 to the camera 215. In addition, the data conversion device 213 may perform a function of processing images transmitted from the camera 215. For example, the data conversion device 213 may capture a still image from the images. For example, when the images are generated by an analog camera, the data conversion device 213 may convert the images into digital signals so that the digital signals are processed by a computer. For example, the data conversion device 213 may process an image transmitted from the camera 215 and then transmit the processed image to another device (e.g., the data processing device 212).

The laser 214 may emit laser beam having various wavelengths, intensities, and phases in response to the control of the central controller 211. For example, when it is necessary to increase in welding speed by evaluating the welding state of the welding object in real time, the intensity of the laser beam emitted from the laser 214 increases. The laser beam emitted from the laser 214 may be reflected by the first mirror 217a to move in a specific direction.

The camera 215 may receive light reflected from the welding object to generate images. The images may be used as data showing the state of the welding object. The first camera 215a may receive the light emitted from the first lighting 230 and reflected from the welding object to generate a seventh image. The second camera 215b may receive the light emitted from the second lighting 240 and reflected from the welding object to generate an eighth image. The images generated by the camera 215 may be transmitted to the data processing device 212 via the data conversion device 213 and may be used to evaluate the welding state in real time. For example, if the light emitted from the first lighting 230 is ultraviolet ray, and the light emitted from the second lighting 230 is visible light, the seventh image may be advantageous for obtaining information sensitive to detailed states or temperature changes at the welding position, whereas the eighth image may be advantageous for obtaining information about an external state or surface texture at the welding position.

In the third embodiment, a period during which the first camera 215a generates the seventh image and a period during which the second camera 215b generates the eighth image may be separated from each other in time. More specifically, the period during which the first camera 215a generates the seventh image may intersect the period during which the second camera 215b generates the eighth image. While the first camera 215a generates the seventh image, the second camera 215b may not generate the eighth image, and while the second camera 215b generates the eighth image, the first camera 215a may not generate the seventh image.

In the third embodiment, the period during which the first camera 215a generates the seventh image may overlap a period during which the second camera 215b transmits the generated eighth image to the data processing device 212 and a period during which the second camera 215b is turned off.

Likewise, in the third embodiment, the period during which the second camera 215b generates the eighth image may overlap a period during which the first camera 215a transmits the seventh image generated by the first camera 215a to the data processing device 112 and a period during which the first camera 215a is turned off.

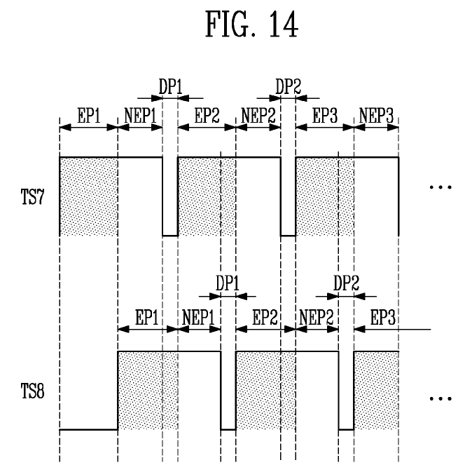

The welding device 200 according to the third embodiment of the present disclosure may cross-generate images by using the first camera 215a and the second camera 215b to double the frame rate compared to the case in which the images are generated using a single camera. For example, when the frame rate of each of the first camera 215a and the second camera 215b of the welding device 200 is about 30 Hz, the camera 215 may generate images at a frame rate of about 60 Hz. The effects of this welding device 100 will be described in detail with reference to FIG. 14.

In addition, the welding device 200 according to the third embodiment includes first and second lightings 230 and 240 that irradiate light having different wavelength bands, and first and second cameras 215a and 215b that receive the light having the different wavelength bands to generate an image. The image of the welding object observed with the light having various wavelengths may be generated, and thus, the welding state may be precisely evaluated from various perspectives.

The scanner 216 may be controlled by the central controller 211 to adjust the traveling direction of the laser beam transmitted from the first mirror 217a so that the laser beam is accurately irradiated onto a desired area of the welding object. In addition, the scanner 216 may adjust the traveling direction of the light reflected from the welding object so that the light is accurately transmitted to the camera 215 via the first mirror 217a.

In embodiments, the scanner 216 may reflect the laser beam and the light from the laser and the welding object in a desired direction to adjust the traveling direction of the light. However, the embodiments of the present disclosure are not necessarily limited thereto. The scanner 216 may adjust the traveling direction of the light reflected from the laser and the welding object in various manners.

The mirrors included in the mirror 217 may be dichroic mirrors that reflect light having a specific wavelength and transmit light having another wavelength through special coating. The first mirror 217a may reflect the laser beam emitted from the laser 214 and transmit the reflected laser beam to the scanner 216. On the other hand, the first mirror 217a may allow the light reflected from the welding object and transmitted through the lens 220 and the scanner 216 to pass without being blocked. The light that has passed through the first mirror 217a and is emitted from the first lighting 230 may be reflected by the second mirror 217b and transmitted to the first camera 215a. On the other hand, the light that has passed through the first mirror 217a and is emitted from the second lighting 240 may pass through the second mirror 217b and be transmitted to the third mirror 217c, and then may be reflected by the third mirror 217c and transmitted to the second camera 215b.

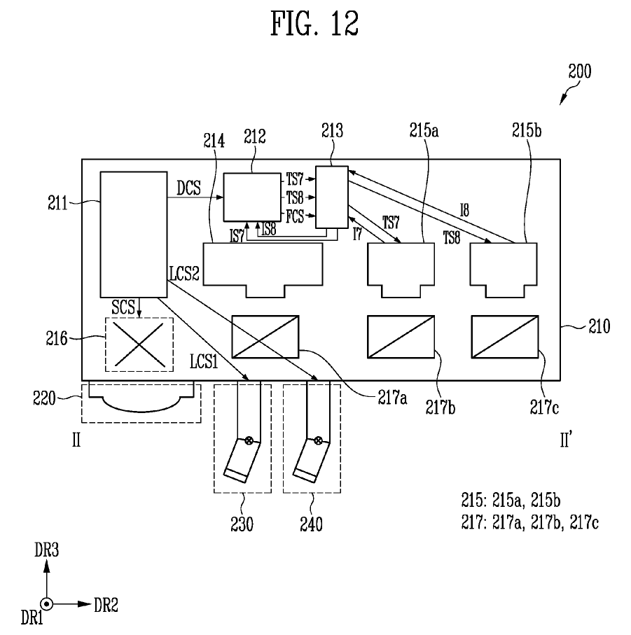

FIG. 12 is a view for explaining a flow of a signal transmitted and received between components of the welding device of FIG. 10.

Referring to FIGS. 10 and 12, the welding device 200 may include a laser 214 that irradiates laser beam having a first wavelength, a first lighting 230 that irradiates light having a second wavelength different from the first wavelength onto a laser irradiation area of a welding object, a second lighting 240 that irradiates light having a third wavelength different from the first wavelength and the second wavelength onto the laser irradiation area of the welding object, a first camera 215a that receives light having the second wavelength, which is reflected from the welding object to generate a seventh image, and a second camera 215b that receives light having the third wavelength, which is reflected from the welding object to generate an eighth image.

In addition, the welding device 200 may include a data processing device 212 that supplies a seventh trigger signal TS7 to the first camera 215a and supplies an eighth trigger signal TS8 to the second camera 215b to thereby control the first camera 215a and the second camera 215b.

In addition, the welding device 200 may include a scanner 216 that adjusts a traveling direction of the light having the second wavelength, which is reflected from the welding object, and the light having the third wavelength, which is reflected from the welding object, a first mirror 217a that receives laser beam from the laser 214 to transmit the laser beam to the scanner 216 and receives the light having the second wavelength, which is reflected from the welding object, to transmit the light having the third wavelength, which is reflected from the welding object, from the scanner 216, a second mirror 217b that receives the light having the second wavelength, from the first mirror 217a to transmit the light to the first camera 215a and transmit the light of the third wavelength received from the first mirror 217a to the second camera 215b, and a third mirror 217c that receives the light having the third wavelength from the second mirror 217b to transmit the light to the second camera 215b.

The central controller 211 may perform a role of managing and controlling operations of the data processing device 212, the laser 214, the scanner 216, the first lighting 230, and the second lighting 240. For example, the central controller 211 may transmit a data control signal DCS to the data processing device 212 to control the data processing device 212, thereby transmitting control signals (e.g., a seventh trigger signal TS7, an eighth trigger signal TS8, and a data conversion device control signal FCS) to the data conversion device 213. For example, the central controller 211 may transmit the scanner control signal SCS to the scanner 216 to control an angle of the scanner 216, etc. For example, the central controller 211 may transmit a first lighting control signal LCS1 to the first lighting 230 to control an on/off operation of the first lighting 230 and may control whether the first lighting 230 emits the light having the second wavelength. For example, the central controller 211 may transmit a second lighting control signal LCS2 to the second lighting 240 to control an on/off operation of the second lighting 240 and may control whether the second lighting 240 emits the light having the third wavelength. For example, the central controller 211 may control the laser 214 to adjust an intensity, a wavelength, a phase, etc., of the laser beam emitted from the laser 214.

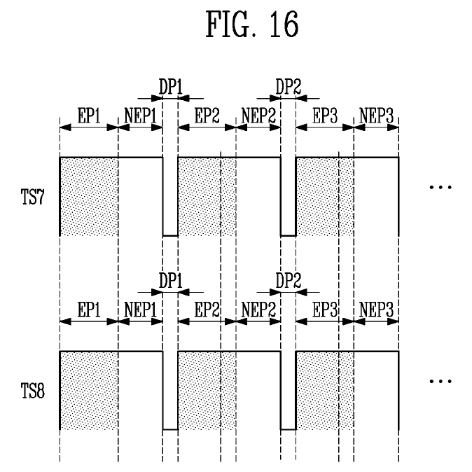

The data processing device 212 may generate and supply, to the data conversion device 213, the data conversion device control signal FCS, the seven trigger signal TS7, and the eighth trigger signal TS8 under the control of the central controller 211. The seventh trigger signal TS7, which is a signal for controlling an operation of the first camera 215a, may be supplied to the first camera 215a via the data conversion device 213. The eighth trigger signal TS8, which is a signal for controlling an operation of the second camera 215b, may be supplied to the second camera 215b via the data conversion device 213. The operations of the first camera 215a and the second camera 215b according to the seventh trigger signal TS7 and the eighth trigger signal TS8 will be described later with reference to FIGS. 14 and 16.

Each of a seventh image I7 generated by the first camera 215a and an eighth image I8 generated by the second camera 215b may be transmitted to the data conversion device 213. The data conversion device 213 may generate a seventh information signal IS7 by converting the first image I1 to match a format of the data processing device 212 so that the data processing device 212 uses the seventh information signal IS7 to recognize the welding state (e.g., the degree of welding progress). The data conversion device 213 may generate an eighth information signal IS8 by converting the eighth image I8 to match a format of the data processing device 212. The generated seventh and eighth information signals IS7 and IS8 may be transmitted to the data processing device 212, and the data processing device 212 may determine a welding state on the basis of the transmitted seventh and eighth information signals IS7 and IS8.

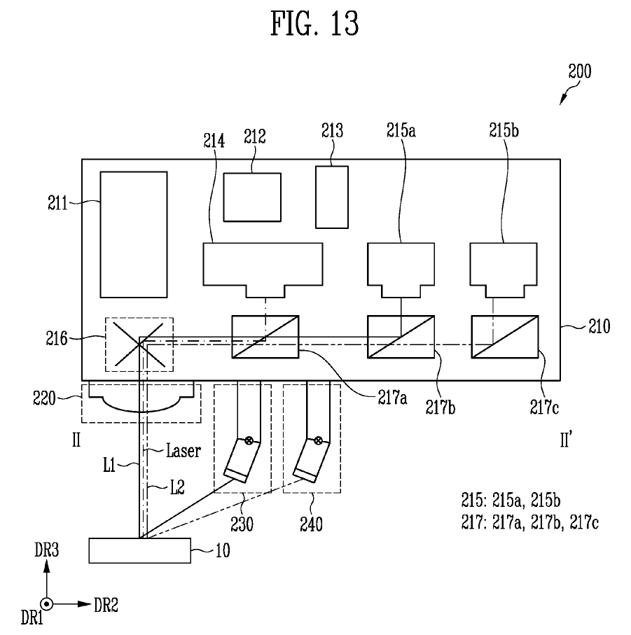

FIG. 13 is a view for explaining a moving path of laser beam, light having a second wavelength, an light having a third wavelength within the welding device of FIG. 10 according to the third embodiment.

Referring to FIGS. 11 and 13, the laser beam having the first wavelength, which is emitted from the laser 214, may be reflected by the first mirror 217a and transmitted to the scanner 216. Thereafter, the laser beam may be reflected again from the scanner 216 and then accurately irradiated onto a desired area of the welding object 10 via the lens 220.

Light L1 having a second wavelength, which is emitted from the first lighting 230, may be reflected from the welding object 10 and transmitted to the scanner 216 via the lens 220. Here, the second wavelength may be in a range of about 400 nm to about 700 nm, but embodiments of the present disclosure are not necessarily limited thereto. The second wavelength may be different from the first wavelength.

Thereafter, the light L1 having the second wavelength may be reflected again from the scanner 216, pass through the first mirror 217a, and be transmitted to the second mirror 217b. Thereafter, the light L1 having the second wavelength may be reflected from the second mirror 217b and may be transmitted to the first camera 215a.

Light L2 having a third wavelength, which is emitted from the second lighting 240, may be reflected from the welding object 10 and transmitted to the scanner 216 via the lens 220. The third wavelength may be in a range of about 10 nm to about 400 nm, but embodiments of the present disclosure are not necessarily limited thereto. The third wavelength may be different from each of the first and second wavelengths.

Thereafter, the light L2 having the third wavelength may be reflected again from the scanner 216, pass through the first mirror 217a and the second mirror 217b, and then be reflected from the third mirror 217c so as to be transmitted to the second camera 215b.

FIG. 14 is a timing view for explaining an effect of the welding device of FIG. 10 according to the third embodiment.

Referring to FIG. 5B, the seventh trigger signal TS7 may be supplied to the first camera 215a to function as a control signal, and the eighth trigger signal TS8 may be supplied to the second camera 215b to function as a control signal.

Each of the seventh trigger signal TS7 and the eighth trigger signal TS8 may be in the form of a pulse. As illustrated in FIG. 14, each of the seventh trigger signal TS7 and the eighth trigger signal TS8 may have a square pulse shape, but embodiments of the present disclosure are not necessarily limited thereto.

When the seventh trigger signal TS7 is at a high level, the first camera 215a may generate a seventh image and may transmit the generated seventh image to the data processing device 212, and when the seventh trigger signal TS7 is at a low level, the first camera 215b may be turned off.

When the eighth trigger signal TS8 is at a high level, the second camera 215b may generate an eighth image and may transmit the generated eighth image to the data processing device 212, and when the eighth trigger signal TS8 is at a low level, the second camera 215b may be turned off.

In the seventh trigger signal TS7, the first to third effective periods EP1 to EP3 may correspond to the periods during which the first camera 215a generates the seventh images. In addition, the first to third non-effective periods NEP1 to NEP3 in the seventh trigger signal TS7 may correspond to periods during which the first camera 215a transmits the seventh images generated by the first camera 115a to the data processing device 212. In addition, the first and second turn-off periods DP1 and DP2 in the seventh trigger signal TS7 may correspond to periods during which the first camera 215a is turned off to stop operating.

In the first effective period EP1 of the seventh trigger signal TS7, the first camera 215a may receive the light emitted from the first lighting 230 and reflected from the welding object to generate a seventh image. In the subsequent first non-effective period NEP1, the generated seventh image may be transmitted to the data processing device 212. In the subsequent first turn-off period DP1, the first camera 215a may be turned off.

In the second effective period EP2 of the seventh trigger signal TS7, the first camera 215a may receive the light emitted from the first lighting 230 and reflected from the welding object to generate the seventh image. In the subsequent second non-effective period NEP2, the generated seventh image may be transmitted to the data processing device 212. In the subsequent second turn-off period DP2, the first camera 215a may be turned off.

In the second effective period EP2 of the third trigger signal TS3, the first camera 215a may receive the light emitted from the first lighting 230 and reflected from the welding object to generate the seventh image. In the subsequent third non-effective period NEP3, the generated seventh image may be transmitted to the data processing device 212. In this manner, the first camera 215a may receive the light reflected from the welding object to generate the seventh image and may transmit the seventh image to the data processing device 212.

In the eighth trigger signal TS8, the first to third effective periods EP1 to EP3 may correspond to periods during which the second camera 215b generates the eighth images. In addition, the first to third non-effective periods NEP1 to NEP3 in the eighth trigger signal TS8 may correspond to periods during which the second camera 215b transmits the eighth images generated therefrom to the data processing device 212. In addition, in the eighth trigger signal TS8, the first and second turn-off periods DP1 and DP2 may correspond to periods during which the second camera 215b is turned off to stop operating.

In the first effective period EP1 of the eighth trigger signal TS8, the second camera 215b may receive the light emitted from the second lighting 240 and reflected from the welding object to generate the eighth image. In the subsequent first non-effective period NEP1, the generated eighth image may be transmitted to the data processing device 212. In the subsequent first turn-off period DP1, the second camera 215b may be turned off.

In the second effective period EP2 of the eighth trigger signal TS8, the second camera 215b may receive the light emitted from the second lighting 240 and reflected from the welding object to generate the eighth image. In the subsequent second non-effective period NEP2, the generated eighth image may be transmitted to the data processing device 212. In the subsequent second turn-off period DP2, the second camera 215b may be turned off.

In the third effective period EP3 of the eighth trigger signal TS8, the second camera 215b may receive the light emitted from the second lighting 240 and reflected from the welding object to generate the eighth image. In the subsequent third non-effective period NEP3, the generated eighth image may be transmitted to the data processing device 212. In this manner, the second camera 215b may receive the light reflected from the welding object to generate the eighth image and may transmit the eighth image to the data processing device 212.

The generation period of the eighth image may overlap the transmission period to the data processing device 212 of the seventh image and the turn-off period of the first camera 215a. For example, the first effective period EP1 of the eighth trigger signal TS8 may overlap the first non-effective period NEP1 and the first turn-off period DP1 of the seventh trigger signal TS7.

Likewise, the generation period of the seventh image may overlap the transmission period to the data processing device 212 of the eighth image and the turn-off period of the second camera 215b. For example, the second effective period EP2 of the seventh trigger signal TS7 may overlap the first non-effective period NEP1 and the first turn-off period DP1 of the eighth trigger signal TS8.

The eighth trigger signal TS8 may be in a form that is delayed by as much as a length of the generation period of the first image with respect to the seventh trigger signal TS7. More specifically, the eighth trigger signal TS8 may be in a form that is delayed by as much as the length of the first effective period EP1 of the seventh trigger signal TS7. Thus, the generation period of the seventh image and the generation period of the eighth image may intersect each other.

In the third embodiment, the length of the generation period of the first image and the length of the transmission period of the first image may be the same. For example, the lengths of the first effective period EP1 and the first non-effective period NEP1 may be the same. For example, the lengths of the second effective period EP2 and the second non-effective period NEP2 may be the same. However, the embodiments of the present disclosure are not necessarily limited thereto.

Referring to FIG. 14, since the welding device 200 includes two cameras, the number of images generated within the same time period may be doubled compared to the case in which the single camera is used. When the camera included in the welding device 100 supports high resolution, precise confirmation of the welding position is possible. Furthermore, the welding object may be by cross-photographed using the plurality of cameras, the frame rate may increase.

The images generated by the camera 215 may be transmitted to the data processing device 212 via the data conversion device 213 and may be used to evaluate the welding state in real time. For example, if the light emitted from the first lighting 230 is ultraviolet ray, and the light emitted from the second lighting 230 is visible light, the first image may be advantageous for obtaining information sensitive to detailed states or temperature changes at the welding position, whereas the second image may be advantageous for obtaining information about an external state or surface texture at the welding position.

The welding device 200 according to the third embodiment includes first and second lightings 230 and 240 that irradiate light having different wavelength bands, and first and second cameras 215a and 215b that receive the light having the different wavelength bands to generate an image. The image of the welding object observed with the light having various wavelengths may be generated, and thus, the welding state may be precisely evaluated from various perspectives.

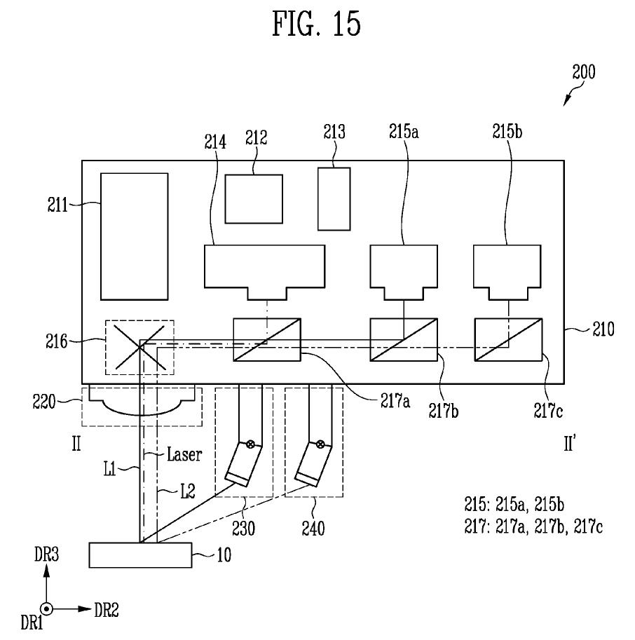

FIG. 15 is a view for explaining a moving path of laser beam, light having a second wavelength, an light having a third wavelength within the welding device of FIG. 10 according to the fourth embodiment.

Referring to FIG. 15, the welding device 200 may include a laser 214 that irradiates laser beam having a first wavelength, a first lighting 230 that irradiates light having a second wavelength different from the first wavelength onto a first area of a welding object, a second lighting 240 that irradiates light having a third wavelength different from each of the first wavelength and the second wavelength onto a second area of the welding object other than the first area, a first camera 215a that receives the light having the second wavelength reflected from the first area of the welding object and generates a seventh image, and a second camera 215b that receives the light having the third wavelength, which is reflected from the second area of the welding object, and generates an eighth image.

The welding device 200 may include a laser, a scanner 216 that adjusts a traveling direction of the light having the second wavelength, which is reflected from the first area, and the light having the third wavelength, which is reflected from the second area, a first mirror 217a that receives the laser beam from the laser 214 and transmits the laser beam to the scanner 216, and receives the light having the second wavelength, which is reflected from the first area, and the light having the third wavelength, which is reflected from the second area, from the scanner 216 to allow the light to pass therethrough, a second mirror 217b that receives the light having the second wavelength from the first mirror 217a and transmits the light to the first camera 215a to allow the light having the third wavelength, which is received from the first mirror 217a, to pass therethrough, and a third mirror 217c that receives the light having the third wavelength from the second mirror 217b and transmits the light to the second camera 215b.

The laser beam having the first wavelength emitted from the laser 214 may be reflected by the first mirror 217a and transmitted to the scanner 216. Thereafter, the laser beam may be reflected again from the scanner 216 and then accurately irradiated onto a desired area of the welding object 10 via the lens 220.

Light L1 having a second wavelength, which is emitted from the first lighting 230, may be reflected from the welding object 10 and transmitted to the scanner 216 via the lens 220. The second wavelength may be in a range of about 400 nm to about 700 nm, but embodiments of the present disclosure are not necessarily limited thereto. The second wavelength may be different from the first wavelength.

Thereafter, the light L1 having the second wavelength may be reflected again from the scanner 216, pass through the first mirror 217a, and be transmitted to the second mirror 217b. Thereafter, the light L1 having the second wavelength may be reflected from the second mirror 217b and may be transmitted to the first camera 215a.

Light L2 having a third wavelength, which is emitted from the second lighting 240, may be reflected from the welding object 10 and transmitted to the scanner 216 via the lens 220. The third wavelength may be in a range of about 400 nm to about 700 nm, but embodiments of the present disclosure are not necessarily limited thereto. The third wavelength may be different from each of the first and second wavelengths.

Thereafter, the light L2 having the third wavelength may be reflected again from the scanner 216, pass through the first mirror 217a and the second mirror 217b, and then be reflected from the third mirror 217c so as to be transmitted to the second camera 215b.

FIG. 16 is a timing view for explaining an effect of the welding device of FIG. 10 according to the fourth embodiment.

Referring to FIG. 16, the seventh trigger signal TS7 may be supplied to the first camera 215a to function as a control signal, and the eighth trigger signal TS8 may be supplied to the second camera 215b to function as a control signal.

Each of the seventh trigger signal TS7 and the eighth trigger signal TS8 may be in the form of a pulse. As illustrated in FIG. 16, each of the seventh trigger signal TS7 and the eighth trigger signal TS8 may have a square pulse shape, but embodiments of the present disclosure are not necessarily limited thereto. The seventh trigger signal TS7 and the eighth trigger signal TS8 may have the same phase.

When the seventh trigger signal TS7 is at a high level, the first camera 215a may generate a seventh image and may transmit the generated seventh image to the data processing device 212, and when the seventh trigger signal TS7 is at a low level, the first camera 215b may be turned off.

When the eighth trigger signal TS8 is at a high level, the second camera 215b may generate an eighth image and may transmit the generated eighth image to the data processing device 212, and when the eighth trigger signal TS8 is at a low level, the second camera 215b may be turned off.

In the seventh trigger signal TS7, the first to third effective periods EP1 to EP3 may correspond to the periods during which the first camera 215a generates the seventh images. In addition, the first to third non-effective periods NEP1 to NEP3 in the seventh trigger signal TS7 may correspond to periods during which the first camera 215a transmits the seventh images generated by the first camera 115a to the data processing device 212. In addition, the first and second turn-off periods DP1 and DP2 in the seventh trigger signal TS7 may correspond to periods during which the first camera 215a is turned off to stop operating.

In the first effective period EP1 of the seventh trigger signal TS7, the first camera 215a may receive the light emitted from the first lighting 230 and reflected from the welding object to generate a seventh image. In the subsequent first non-effective period NEP1, the generated seventh image may be transmitted to the data processing device 212. In the subsequent first turn-off period DP1, the first camera 215a may be turned off.

In the second effective period EP2 of the seventh trigger signal TS7, the first camera 215a may receive the light emitted from the first lighting 230 and reflected from the welding object to generate the seventh image. In the subsequent second non-effective period NEP2, the generated seventh image may be transmitted to the data processing device 212. In the subsequent second turn-off period DP2, the first camera 215a may be turned off.

In the second effective period EP2 of the third trigger signal TS3, the first camera 215a may receive the light emitted from the first lighting 230 and reflected from the welding object to generate the seventh image. In the subsequent third non-effective period NEP3, the generated seventh image may be transmitted to the data processing device 212. In this manner, the first camera 215a may receive the light reflected from the welding object to generate the seventh image and may transmit the seventh image to the data processing device 212.

In the eighth trigger signal TS8, the first to third effective periods EP1 to EP3 may correspond to periods during which the second camera 215b generates the eighth images. In addition, the first to third non-effective periods NEP1 to NEP3 in the eighth trigger signal TS8 may correspond to periods during which the second camera 215b transmits the eighth images generated therefrom to the data processing device 212. In addition, in the eighth trigger signal TS8, the first and second turn-off periods DP1 and DP2 may correspond to periods during which the second camera 215b is turned off to stop operating.

In the first effective period EP1 of the eighth trigger signal TS8, the second camera 215b may receive the light emitted from the second lighting 240 and reflected from the welding object to generate the eighth image. In the subsequent first non-effective period NEP1, the generated eighth image may be transmitted to the data processing device 212. In the subsequent first turn-off period DP1, the second camera 215b may be turned off.

In the second effective period EP2 of the eighth trigger signal TS8, the second camera 215b may receive the light emitted from the second lighting 240 and reflected from the welding object to generate the eighth image. In the subsequent second non-effective period NEP2, the generated eighth image may be transmitted to the data processing device 212. In the subsequent second turn-off period DP2, the second camera 215b may be turned off.

In the third effective period EP3 of the eighth trigger signal TS8, the second camera 215b may receive the light emitted from the second lighting 240 and reflected from the welding object to generate the eighth image. In the subsequent third non-effective period NEP3, the generated eighth image may be transmitted to the data processing device 212. In this manner, the second camera 215b may receive the light reflected from the welding object to generate the eighth image and may transmit the eighth image to the data processing device 212.

The generation period of the eighth image may overlap the generation period of the seventh image. For example, the first effective period EP1 of the eighth trigger signal TS8 may overlap the first effective period EP1 of the seventh trigger signal TS7.

In the fourth embodiment, the length of the generation period of the seventh image and the length of the transmission period of the eighth image may be the same. For example, the lengths of the first effective period EP1 and the first non-effective period NEP1 may be the same. For example, the lengths of the second effective period EP2 and the second non-effective period NEP2 may be the same. However, the embodiments of the present disclosure are not necessarily limited thereto.

The welding device 200 according to the fourth embodiment of the present disclosure may differently align the photographing area of the welding object by using the plurality of cameras (e.g., the first camera 215a and the second camera 215b). For example, the first lighting 230 may irradiate the light having the second wavelength onto the first area, and the light may be reflected from the first area of the welding object and transmitted to the first camera 215a. The second lighting 240 may irradiate the light having the third wavelength onto the second area, and the light may be reflected from the second area of the welding object and transmitted to the second camera 215b. The images may be generated simultaneously by the first camera 215a and the second camera 215b to secure a wider viewing angle. For example, compared to using the single camera, the images generated by the first camera 215a and the second camera 215b include the first area and the second area to provide wider field of vision.

According to an embodiment of the present disclosure, the welding object may be cross-photographed using the plurality of cameras to more precisely evaluate the welding state and improve the accuracy in the selection of the welding position.

According to another embodiment of the present disclosure, the photographing area of the welding object may be differently aligned and simultaneously photographed using the plurality of cameras to secure the wider viewing angle.

According to further another embodiment of the present disclosure, the various welding states of the welding object may be precisely evaluated using the lightings having the different wavelength bands and the camera that recognize the lightings.

The above-mentioned descriptions are specific embodiments to practice the present invention. However, the present invention will include not only the embodiments described above, but also embodiments which may be simply redesigned or easily modified. In addition, the present invention will also include techniques which may be easily modified and practiced using the embodiments described above. Therefore, the scope of the present invention should not be limited to the embodiments described above, but should be determined by the appended claims as well as their equivalents.

What is claimed is:

1. A welding device comprising:
a laser configured to irradiate laser beam having a first wavelength toward a welding object;
a lighting configured to irradiate light having a second wavelength different from the first wavelength onto a laser irradiation area of the welding object;
a first camera configured to receive the light having the second wavelength, which is reflected from the welding object, so as to generate a first image; and
a second camera configured to receive the light having the second wavelength, which is reflected from the welding object, so as to generate a second image,
wherein a generation period of the first image and a generation period of the second image intersect each other.

2. The welding device of claim 1, further comprising a data processing device configured to supply a first trigger signal to the first camera and supply a second trigger signal to the second camera so as to control the first camera and the second camera,
wherein the first trigger signal is in the form of a pulse, and
the second trigger signal is in the form of the first trigger signal that is delayed by as much as a length of the generation period of the first image.

3. The welding device of claim 2, wherein, when the first trigger signal is at a high level, the first camera is configured to generate the first image and transmit the generated first image to the data processing device, and when the first trigger signal is at a low level, the first camera is turned off,
when the second trigger signal is at a high level, the second camera is configured to generate the second image and transmit the generated second image to the data processing device, and when the second trigger signal is at a low level, the second camera is turned off, and
the generation period of the second image overlaps a transmission period of the first image and a turn-off period of the first camera.

4. The welding device of claim 3, wherein the lengths of the generation period of the first image and the transmission period of the first image are the same.

5. The welding device of claim 2, further comprising:
a beam splitter configured to separate the light having the second wavelength, which is reflected from the welding object, and transmit the separated light to the first camera and the second camera, respectively;
a scanner configured to adjust a traveling direction of the light having the second wavelength, which is reflected from the laser and the welding object;
a first mirror configured to receive the laser beam from the laser and transmit the received laser beam to the scanner, and receive the light having the second wavelength, which is reflected from the welding object, and transmit the received light from the scanner; and
a second mirror configured to receive the light having the second wavelength from the first mirror and transmit the light to the beam splitter.

6. The welding device of claim 5, wherein the light having the second wavelength, which is separated by the beam splitter and transmitted to the first camera and the second camera, have the same phase.

7. The welding device of claim 5, wherein the second wavelength is in a range of about 400 nm to about 700 nm.

8. A welding device comprising:
a laser configured to irradiate laser beam having a first wavelength toward a welding object;
a lighting configured to irradiate light having a second wavelength different from the first wavelength onto a laser irradiation area of the welding object;
a first camera configured to receive the light having the second wavelength, which is reflected from the welding object, so as to generate a first image;
a second camera configured to receive the light having the second wavelength, which is reflected from the welding object, so as to generate a second image;
a third camera configured to receive the light having the second wavelength, which is reflected from the welding object, so as to generate a third image; and
a fourth camera configured to receive the light having the second wavelength, which is reflected from the welding object, so as to generate a fourth image,
wherein periods during which the first to fourth images are generated do not overlap each other and are sequentially repeated.

9. The welding device of claim 8, further comprising a data processing device configured to supply a first trigger signal to the first camera, supply a second trigger signal to the second camera, supply a third trigger signal to the third camera, and supply a fourth trigger signal to the fourth camera so as to control the first to fourth cameras,
wherein the first trigger signal is in the form of a pulse,
the second trigger signal is in a form in which the first trigger signal that is delayed by as much as a length of the generation period of the first image,
the third trigger signal is in a form in which the second trigger signal is delayed by as much as a length of the generation period of the second image, and
the fourth trigger signal is in a form in which the third trigger signal delayed by as much as a length of the generation period of the third image.

10. The welding device of claim 9, wherein, when the first trigger signal is at a high level, the first camera is configured to generate the first image and transmit the generated first image to the data processing device, and when the first trigger signal is at a low level, the first camera is turned off,
when the fourth trigger signal is at a high level, the fourth camera is configured to generate the fourth image and transmit the generated fourth image to the data processing device, and when the fourth trigger signal is at a low level, the fourth camera is turned off, and
the generation period of the fourth image overlaps a transmission period of the first image and a turn-off period of the first camera.

11. A welding device comprising:
a laser configured to irradiate laser beam having a first wavelength toward a welding object;
a first lighting configured to irradiate light having a second wavelength different from the first wavelength onto a laser irradiation area of the welding object;
a second lighting configured to irradiate light having a third wavelength different from each of the first wavelength and the second wavelength onto the laser irradiation area of the welding object;
a first camera configured to receive the light having the second wavelength, which is reflected from the welding object, so as to generate a first image; and
a second camera configured to receive the light having the third wavelength, which is reflected from the welding object, so as to generate a second image,
wherein a generation period of the first image and a generation period of the second image intersect each other.

12. The welding device of claim 11, further comprising a data processing device configured to supply a first trigger signal to the first camera and supply a second trigger signal to the second camera so as to control the first camera and the second camera,
wherein the first trigger signal is in the form of a pulse, and
the second trigger signal is in the form of the first trigger signal that is delayed by as much as a length of the generation period of the first image.

13. The welding device of claim 12, wherein, when the first trigger signal is at a high level, the first camera is configured to generate the first image and transmit the generated first image to the data processing device, and when the first trigger signal is at a low level, the first camera is turned off,
when the second trigger signal is at a high level, the second camera is configured to generate the second image and transmit the generated second image to the data processing device, and when the second trigger signal is at a low level, the second camera is turned off, and
the generation period of the second image overlaps a transmission period of the first image and a turn-off period of the first camera.

14. The welding device of claim 11, further comprising:
a scanner configured to adjust traveling directions of the laser beam, the light having the second wavelength, which is reflected from the welding object, and the light having the third wavelength, which is reflected from the welding object;
a first mirror configured to receive the laser beam from the laser and transmit the received laser beam to the scanner, and receive the light having the second wavelength and the light having the third wavelength, which are reflected from the welding object, from the scanner and allow the light to pass therethrough;
a second mirror configured to transmit the light having the second wavelength, which is received from the first mirror, to the first camera, and allow the light having the third wavelength, which is received from the first mirror, to pass therethrough; and
a third mirror configured to transmit the light having the third wavelength, which is received from the second mirror, to the second camera.

15. The welding device of claim 11, wherein the second wavelength is in a range of about 400 nm to about 700 nm, and
the third wavelength is in a range of about 200 nm to about 400 nm.

16. A welding device comprising:
a laser configured to irradiate laser beam having a first wavelength toward a welding object;
a first lighting configured to irradiate light having a second wavelength different from the first wavelength onto a first area of the welding object;
a second lighting configured to irradiate light having a third wavelength different from each of the first wavelength and the second wavelength onto a second area other than the first area of the welding object;
a first camera configured to receive the light having the second wavelength, which is reflected from the first area of the welding object, so as to generate a first image; and
a second camera configured to receive the light having the third wavelength, which is reflected from the second area of the welding object, so as to generate a second image,
wherein a generation period of the first image and a generation period of the second image overlap each other.

17. The welding device of claim 16, further comprising a data processing device configured to supply a first trigger signal to the first camera and supply a second trigger signal to the second camera so as to control the first camera and the second camera,
wherein the first trigger signal is in the form of a pulse, and
the second trigger signal has the same phase as the first trigger signal.

18. The welding device of claim 17, wherein, when the first trigger signal is at a high level, the first camera is configured to generate the first image and transmit the generated first image to the data processing device, and when the first trigger signal is at a low level, the first camera is turned off, and
when the second trigger signal is at a high level, the second camera is configured to generate the second image and transmit the generated second image to the data processing device, and when the second trigger signal is at a low level, the second camera is turned off.

19. The welding device of claim 16, further comprising:
a scanner configured to adjust traveling directions of the laser beam, the light having the second wavelength, which is reflected from the first area, and the light having the third wavelength, which is reflected from the second area;
a first mirror configured to receive the laser beam from the laser and transmit the received laser beam to the scanner, and receive the light having the second wavelength, which is reflected from the first area, and the light having the third wavelength, which is reflected from the second area, from the scanner and allow the light to pass therethrough;
a second mirror configured to receive the light having the second wavelength, which is reflected from the first area, from the first mirror and transmit the received light to the first camera, and receive the light having the third wavelength, which is reflected from the second area, from the first mirror and allow the light to pass therethrough; and
a third mirror configured to receive the light having the third wavelength, which is reflected from the second area, from the second mirror and transmit the light to the second camera.

20. The welding device of claim 11, wherein each of the second wavelength and the third wavelength is in a range of about 400 nm to about 700 nm.
